(19) United States
(12) Patent Application Publication
(10) Pub. No.: US 2019/0168301 A1
(43) Pub. Date: Jun. 6, 2019

(54) TUNABLE LAYER ADHESION FOR FUSED FILAMENT FABRICATION OF METALLIC BUILD MATERIALS

(71) Applicant: Desktop Metal, Inc., Burlington, MA (US)

(72) Inventors: Nicholas Graham Bandiera, Burlington, MA (US); Uwe Bauer, Cambridge, MA (US); Emanuel Michael Sachs, Newton, MA (US)

(21) Appl. No.: 16/165,551

(22) Filed: Oct. 19, 2018

Related U.S. Application Data
(60) Provisional application No. 62/575,092, filed on Oct. 20, 2017.
(60) Provisional application No. 62/575,133, filed on Oct. 20, 2017.

(51) Int. Cl. B22F 3/105; B22F 3/10

(52) U.S. Cl. CPC B22F 3/1055; B33Y 10/00; B22F 3/1017

(57) ABSTRACT

Fused filament fabrication using metal based multi-phase (MBMP) build materials, creates a build with object portions and support portions adhered to each other that must be separated. Different object portions are more delicate or problematic than others. Methods for tuning or specifying the strength of adhesion at interfaces between such object and support portions include providing a release skin of powder or other material at such interfaces. Strength of adhesion also varies based on the liquid fraction of material deposited to form interfaces, generally with relatively higher liquid fraction leading to stronger adhesion. Liquid fraction is governed by MBMP material composition and temperature at deposition. Strength can be tuned by printing interfaces of the same material at different temperatures, or different materials at the same or different temperatures. Support portions may be entirely of weaker adhesion. Joining portions may separate with object or support.

### CROSS-REFERENCE TO RELATED APPLICATIONS

This application claims priority to U.S. Provisional App. No. 62/575,092 filed on Oct. 20, 2017, entitled Extrusion Nozzle For Semi-Solid Metal Additive Manufacturing, the full disclosure of which is hereby incorporated herein by reference in its entirety. This application also claims priority to U.S. Provisional App. No. 62/575,133, filed on Oct. 20, 2017, entitled Semi-Solid Metal Additive Manufacturing, the full disclosure of which is also hereby herein incorporated by reference in its entirety.

This application is also related to the following U.S. patent applications: U.S. Prov. App. No. 62/268,458, filed on Dec. 16, 2015; U.S. application Ser. No. 15/382,535, filed on Dec. 16, 2016; International App. No. PCT/US17/20817 filed on Mar. 3, 2017; U.S. application Ser. No. 15/450,562, filed on Mar. 6, 2017, U.S. Prov. App. No. 62/303,310, filed on Mar. 3, 2016; U.S. application Ser. No. 15/059,256 filed, on Mar. 2, 2016; U.S. application Ser. No. 16/035,296, filed on Jul. 13, 2018, entitled THERMALLY ROBUST NOZZLE FOR 3-DIMENSIONAL PRINTING AND METHODS OF USING SAME; U.S. application Ser. No. 16/038,057, filed on Jul. 17, 2018, entitled ADDITIVE FABRICATION USING VARIABLE BUILD MATERIAL FEED RATES; and U.S. application Ser. No. 16/125,181, filed on Sep. 7, 2018, entitled NOZZLE SERVICING TECHNIQUES FOR ADDITIVE FABRICATION SYSTEMS. Each the foregoing applications is hereby incorporated herein by reference in its entirety.

### FIELD

The present disclosure generally relates to additive manufacturing, and more specifically to a fused filament fabrication using a nozzle and metal based multi-phase build material, and more specifically to the three-dimensional printing of metal objects, and methods and apparatus for fabricating builds that have separable components, such as an object portion and support portions, which are separated after initial fabrication, before use.

### BACKGROUND

Using fused filament fabrication techniques, to make objects with complex geometries, temporary structures, known as supports, are required. A build generally includes the object or objects of interest and any support structures. Supports typically are not part of the final object and must be separated from the object. Fabricating objects from metal build materials generally results also in the support structures, being made from metal, as well as joining portions between the object and the support (which joining portions may, essentially, become part of either or neither, or both). Because these joining and support portions are typically metal, they are rather durable, and thus, require special considerations to separate them. Often they support rather delicate portions of objects. Such separation considerations entail additional planning before and steps after the object has been printed, and also the time and expense of such steps. These steps are costly. It would be desirable to avoid them. Further, some portions of objects are delicate, and it would be desirable to provide relatively low strengths of adhesion between these delicate portions and any adjacent supports. Ease of separating different portions of an object or a build would benefit from different, specifically tunable, or customizable strengths of adhesion between the object and the support. Thus, the several objects of the present teachings hereof include but are not limited to providing methods of tuning strength of adhesion at different locations within an object build, particularly between object portions and support portions, to a specific strength. It would be desirable to provide such specific, tuned strength using conventional FFF equipment, and at the time the build is fabricated.

### SUMMARY

A method aspect of the present teachings hereof is a method of fabricating a fused filament fabrication FFF build from (metal based multi phase) MBMP material, comprising an object portion and a support portion. The method may comprise: fabricating an object portion by depositing by FFF an BMCP object material that has an object composition and an object liquid fraction at deposition; fabricating a joining portion by depositing by FFF a MBMP joining material that has a joining composition and a joining liquid fraction at deposition, so that the joining portion is adhered to the object portion with a strength of object-and-joining adhesion; and fabricating a support portion by depositing by FFF MBMP material selected from the group consisting of: the object material and the joining material, so that the support portion is adhered to the joining portion with a strength of support-and-joining adhesion. The object and joining materials and their respective liquid fractions at deposition having been chosen such that the strength of object-and-joining adhesion differs from the strength of support-and-joining adhesion. The strength of object-and-joining adhesion may be greater or less than the strength of support-and-joining adhesion. The strength of object-and-joining adhesion may differ from the strength of support-and-joining adhesion such that upon separation, the joining portion separates from the object portion and adheres to the support portion, or, such that upon separation, the joining portion separates from the support portion and adheres to the object portion. The step of fabricating a support portion may comprise depositing object material, or joining material. The object material and the joining material may have the same composition and different liquid fractions at deposition. The support material and the joining material may have the same composition and different liquid fractions at deposition. The object material and the joining material may comprise the same composition material. The object material and the joining material may comprise different composition material. The object material liquid fraction may be greater than the joining material liquid fraction.

A related aspect of the present teachings hereof is a build fabricated by fused filament fabrication FFF from (metal based multi phase) MBMP material, comprising an object portion and a support portion. The build may comprise: an object portion comprising a MBMP object material that has an object composition and an object liquid fraction at deposition; a joining portion comprising a MBMP joining material that has a joining composition and a joining liquid fraction at deposition, the joining portion adhered to the object portion with a strength of object-and-joining adhesion; and a support portion comprising a MBMP material selected from the group consisting of: the object material and the joining material, the support portion adhered to the joining portion with a strength of support-and-joining adhesion that differs from the strength of object-and-joining adhesion. The strength of object-and-joining adhesion may be less than or greater than the strength of support-and-joining adhesion. The strength of object-and-joining adhesion may differ from the strength of support-and-joining adhesion such that upon separation, the joining portion separates from the object portion and adheres to the support portion, or, such that the joining portion separates from the support portion and adheres to the object portion. The support portion may comprise joining material or object material. The object material and the joining material may have the same composition and different liquid fractions at deposition. The support material and the joining material having the same composition and different liquid fractions at deposition. The object material and the joining material may comprise the same composition material or different composition material. The object material liquid fraction may be greater than the joining material liquid fraction.

Another aspect of the present teachings hereof is a method for fabricating a fused filament fabrication build from metal based multi-phase (MBMP) build material. The method may comprise the steps of: fabricating a first, build plurality of layers of lines of build material, with a first build strength of adhesion between the layers of the first build plurality; and fabricating a second build plurality of layers of lines of build material, with a second build strength of adhesion between the layers of the second plurality, by depositing a first layer of the second build plurality of layers upon the first build plurality of layers, with a second build strength of adhesion between layers of the second build plurality, the step of depositing a first layer of the second build plurality of layers upon the first build plurality of layers comprising a method that establishes an interface strength of adhesion between the first build plurality and the second build plurality, which interface strength of adhesion is less than each of the first build strength of adhesion and the second strength of adhesion.

A related aspect of the present teachings hereof is an object fabricated by fused filament fabrication from metal based multi-phase (MBMP) build material. The object may comprise: a first, build plurality of layers of lines of build material, with a first build strength of adhesion between the layers of the first build plurality; and a second build plurality of layers of lines of build material, with a second build strength of adhesion between the layers of the second plurality, a first layer of the second build plurality of layers adhered to the first build plurality of layers, with a second build strength of adhesion between layers of the second build plurality, such that there is an interface between the first layer of the second build plurality of layers and the first build plurality of layers, the interface having an interface strength of adhesion between the first build plurality and the second build plurality, which interface strength of adhesion is less than each of the first build strength of adhesion and the second strength of adhesion.

Still another aspect of the present teachings hereof is a method for fabricating an object by fused filament fabrication from metal based multi-phase (MBMP) build material. The method may comprise the steps of: fabricating a first, build plurality of layers of lines of build material, with a first build strength of adhesion between the layers of the first build plurality; depositing a release skin onto a layer of the first build plurality of layers, with a first release strength of adhesion between the release skin and the first build plurality of layers, which first release strength is less than the first build strength of adhesion; fabricating a second build plurality of layers of lines of build material, with a second build strength of adhesion between the layers of the second plurality, by depositing a first layer of the second build plurality of layers upon the release skin with a second release strength of adhesion between the release skin and the second plurality of layers, which second release strength of adhesion is less than the first build strength of adhesion and thereafter depositing at least one additional layer of the second build plurality of layers, with a second build strength of adhesion between layers of the second build plurality that is greater than the first and the second release strengths of adhesion. Rather than depositing a second plurality of layers upon the release skin, a single layer may be deposited. The first, build plurality of layers may comprising a plurality of support layers of a build, and the second build plurality of layers may comprise a plurality of object layers of a build.

Finally, a related aspect of this embodiment is an object fabricated from metal based multi-phase (MBMP) build material. The object may comprise: a first, build plurality of layers of lines of build material, with a first build strength of adhesion between the layers of the first build plurality; a release skin adhered to a layer of the first build plurality of layers, with a first release strength of adhesion between the release and the first build plurality of layers, which first release strength is less than the first build strength of adhesion; and a second build plurality of layers of lines of build material, with a second build strength of adhesion between the layers of the second plurality, a first layer of the second build plurality of layers adhered to the release skin with a second release strength of adhesion between the release skin and the second plurality of layers, which second release strength of adhesion is less than the first build strength of adhesion and the second build plurality of layers comprising at least one additional layer, with a second build strength of adhesion between layers of the second build plurality that is greater than the first and the second release strengths of adhesion. The first, build plurality of layers may comprise a plurality of support layers of a build, and the second build plurality of layers comprising a plurality of object layers of a build.

### BRIEF DESCRIPTION OF THE DRAWINGS

The foregoing and other objects, features and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein.

FIG. 1 shows schematically, in block diagram form, an additive manufacturing system.

FIG. 2 shows a phase diagram for a generic eutectic system, for which, within a temperature range, there are compositions that exist in a multi-phase condition of at least one solid phase and one liquid phase.

FIG. 3 shows, schematically, an extruder for fused filament fabrication additive manufacturing, including various sensors.

FIG. 4A shows, schematically in cross-section a structure resulting from the deposition of a release skin and FIG. 4B shows the structure of FIG. 4A, in an enlarged view in Detail B.

FIG. 5 shows an apparatus for depositing a release skin.

FIG. 6 shows an interrupted deposition of a release skin.

FIG. 7 shows a flowchart of steps for the fabrication of an object with support structures via fused filament fabrication employing a release skin.

FIG. 8 shows a simplified liquid fraction versus temperature plot for a MBMP material.

FIGS. 9A-9C shows a layering sequence for a printing one semi-solid material at different temperatures.

FIG. 10 shows a flowchart of steps for the fabrication of an object with support structures via fused filament fabrication employing one build material printed at different temperatures.

FIG. 11 shows a liquid fraction versus temperature plot for a zinc-aluminum alloy.

FIG. 12 shows a simplified liquid fraction versus temperature plot for two semi-solid materials.

FIGS. 13A-13B show layering sequences for printing with two MBMP materials.

FIG. 14 shows a liquid fraction versus temperature plot for two zinc-aluminum alloy compositions.

FIG. 15 shows a flowchart of steps for the fabrication of an object with support structures via fused filament fabrication employing two build materials.

FIGS. 16A-16B show an example object and support structure.

FIGS. 17A-17B show another example object and support structure.

### DESCRIPTION

Embodiments will now be described with reference to the accompanying figures. The foregoing may, however, be embodied in many different forms and should not be construed as limited to the illustrated embodiments set forth herein.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately” or the like, when accompanying a numerical value, are to be construed as indicating a deviation as would be appreciated by one of ordinary skill in the art to operate satisfactorily for an intended purpose. Similarly, words of approximation such as “approximately” or “substantially” when used in reference to physical characteristics, should be understood to contemplate a range of deviations that would be appreciated by one of ordinary skill in the art to operate satisfactorily for a corresponding use, function, purpose, or the like. Ranges of values and/or numeric values are provided herein as examples only, and do not constitute a limitation on the scope of the described embodiments. Where ranges of values are provided, they are also intended to include each value within the range as if set forth individually, unless expressly stated to the contrary. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms unless specifically stated to the contrary.

Described herein are devices, systems, and methods for tunable layer adhesion for fused filament fabrication of metallic build materials. Before that discussion, however, will be discussed the general FFF 3D printing equipment that is suitable for use with the present teachings. Mention will also be made of the materials for which benefits have been found using the techniques and apparatus disclosed herein.

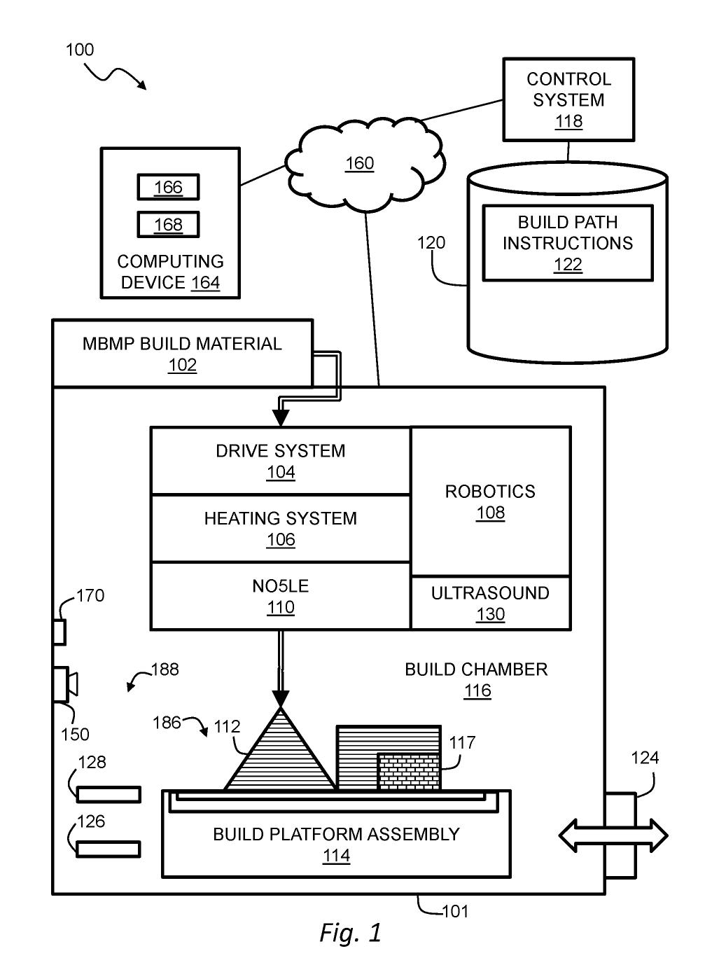

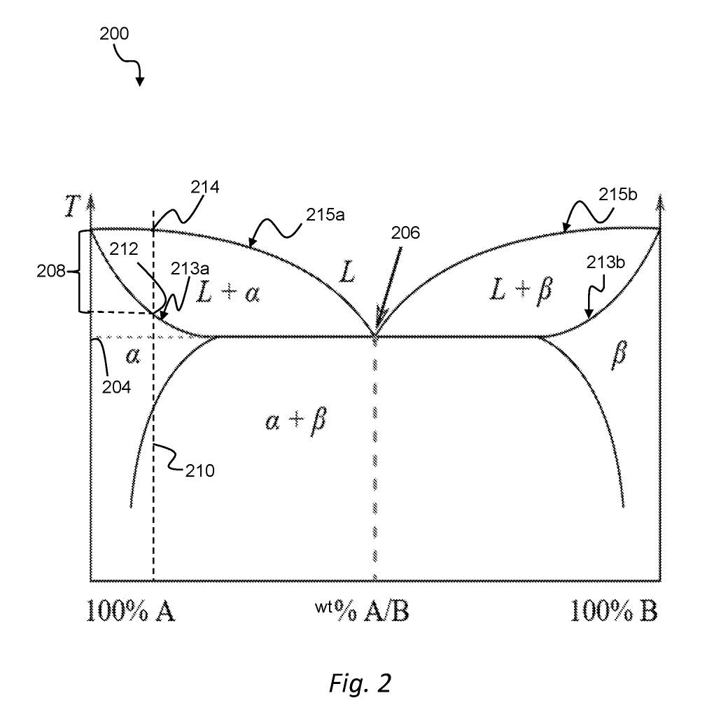

FIG. 1 is a schematic block diagram of an additive manufacturing system 100. In general, the additive manufacturing system may include a three-dimensional printer 101 (or simply printer 101) that deposits a metal, metal alloy, metal composite or the like, using fused filament fabrication or any similar process. In general, the printer 101 may include a multi-phase metallic build material 102 that is propelled by a drive system 104 and heated to an extrudable state by a heating system 106, and then extruded through one or more nozzles 110. By concurrently controlling robotics 108 to position the nozzle(s) along an extrusion path relative to a build platform unit 114, an object 112 and support structure 117 may be fabricated on the build platform unit 114 which may be situated within a build chamber 116. In general, a control system 118 may manage operation of the printer 101 to fabricate the object 112 and support structure 117 according to build path instructions 122 based on a three-dimensional model using a fused filament fabrication process or the like. FIG. 2 shows a phase diagram for one of the types of materials suitable as a build material and is discussed together with other types of suitable build material, below.

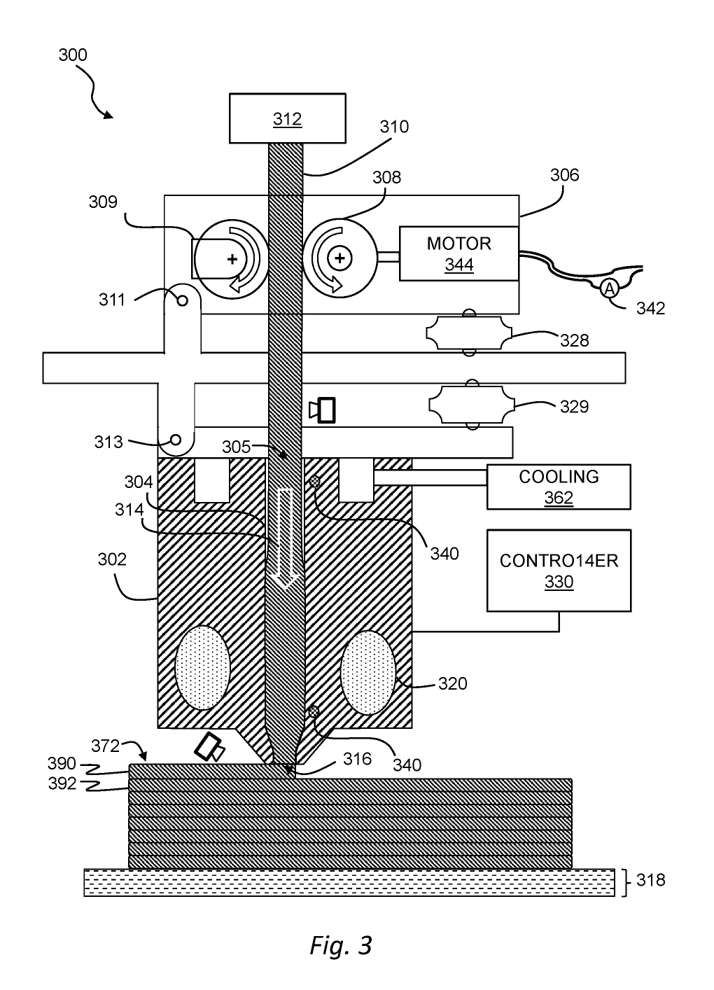

FIG. 3 shows an extruder 300 for a three-dimensional printer. In general, the extruder 300 may include a nozzle 302, a nozzle bore 304, a heating system 320, and a build material drive system 308 such as any of the systems described herein, or any other devices or combination of devices suitable for a printer that fabricates an object from a computerized model using a fused filament fabrication process and a metallic build material as contemplated herein. In general, the extruder 300 may receive a build material 310 from a source 312, such as any of the build materials and sources described herein, and advance the build material 310 along a feed path (indicated generally by an arrow 314) toward an opening 316 of the nozzle 302 for deposition on a build platform unit 318 or other suitable surface. The term build material is used herein interchangeably to refer to metallic build material, species and combinations of metallic build materials, or any other build materials, all as discussed below. As such, references to build material 310 should be understood to include metallic build materials, or multi-phase metallic build materials or any of the other build material or combination of build materials described herein, under specific conditions, unless a more specific meaning is provided or otherwise clear from the context.

Many metallic build materials may be used with the techniques described herein. In general, any build material with metallic content that provides a useful working temperature range with rheological behavior suitable for heated extrusion may be used as a metallic build material as contemplated herein. One particularly desirable class of metallic build materials are metallic multi-phase materials. Such multi-phase materials can be any wholly or partially metallic mixture that exhibits a working temperature range in which at least one solid phase and at least one liquid phase co-exist, resulting in a rheology suitable for fused filament fabrication or similar techniques described herein. Typically, build materials are processed at the nozzle operating temperature which is selected to fall within the working temperature range of the build material.

In earlier cases filed in the name of the same applicant, Desktop Metal, Inc. the term metal containing multi-phase materials (i.e., MCMP materials in shortened form), was used to refer to suitable build materials for metal FFF. MCMP build materials referred to a wide range of metallic multi-phase build materials including metal alloys, metallic materials with high temperature inert phase and metal-loaded extrudable composites. Here, focus is upon all the MCMP materials other than metal-loaded extrudable composites and this large subset of MCMP build materials is referred to herein as metal-based multi-phase materials, referred to in shortened form as MBMP materials.

Here, a MBMP material will be used to refer to all of the materials that are about to be described, and any other suitable materials not explicitly mentioned, but which exhibits a working temperature range in which at least one solid phase and at least one liquid phase co-exist, resulting in a rheology suitable for fused filament fabrication or similar techniques described herein. These MBMP materials are described more fully in the U.S. application Ser. No. 16/038,057 mentioned and incorporated by reference above.

In one aspect, a MBMP build material may be a metal alloy that exhibits a multi-phase equilibrium between at least one solid and at least one liquid phase. Such a semi-solid state may provide a working temperature range with rheological behavior suitable for use in fused filament fabrication as contemplated herein. For example, the metal alloy may, within the working temperature range, form a non-Newtonian paste or Bingham fluid with a non-zero shear stress at zero shear strain. While the viscous fluid nature of the material permits extrusion or other similar deposition techniques, this non-Newtonian characteristic can permit the deposited material to retain its shape against the force of gravity so that a printed object can retain a desired form until the material cools below a solidus or eutectic temperature of the metallic base.

For example, a composition of a eutectic alloy system, which is not the eutectic composition, may exhibit such a multiphase equilibrium. Compositions within an alloy system with a eutectic may melt over a range of temperatures rather than at a melting point and thus provide a semi-solid state with a mixture of at least one solid and at least one liquid phase that collectively provide rheological behavior suitable for fused filament fabrication or similar additive fabrication techniques.

FIG. 2 shows a phase diagram 200 for a simple eutectic alloy system, exhibiting an alloy composition suitable for use as a MBMP build material in the methods and systems described herein. The eutectic composition is the composition present at the vertical dashed line that intersects the point 206. The point 206 is at the intersection of the lines that represent the eutectic composition (vertical dashed) and the eutectic temperature 204. In general, the build material may include an alloy with a working temperature range in which the mixture contains a solid and liquid phase in an equilibrium proportion dependent on temperature. The solid and liquid phases coexist within the temperature and composition combinations within the two bound regions labeled as L+α and L+β respectively. This notation signifies that within that region, the build material exists as a mixture of a liquid phase L made up of components A and B and a solid phase with a specific crystalline structure. The solid phase is denoted as α, for compositions to the left of the eutectic composition (higher concentrations of component A) and as β for compositions to the right of the eutectic composition (higher concentrations of component B). Where α denotes a solid solution of B in an A matrix and β denotes a solid solution of A in a B matrix. This multi-phase condition usefully increases viscosity of the material above the pure liquid viscosity while in the working temperature range to render the material in a flowable state exhibiting rheological behavior suitable for fused filament fabrication or similar extrusion-based additive manufacturing techniques.

Also on the phase diagram 200, the composition and temperature combinations above the liquidus curves 215a and 215b will be a single liquid phase L. When an alloy in a eutectic alloy system solidifies, its components may solidify at different temperatures, resulting in a semi-solid suspension of solid and liquid components prior to full solidification. The working temperature for such an alloy composition is generally a range of temperatures between a lowest and highest melting temperature. In a mixture around the eutectic point 206, the lowest melting temperature (at which this mixture remains partially molten) is the eutectic temperature 204. The highest melting temperature will generally be a function of the percentage of the components A and B. In regions far from the eutectic composition such that the eutectic line terminates, i.e., at the far left or the far right of the phase diagram 200, the lowest melting temperature may be somewhat above the eutectic temperature, at the solidus temperature of the alloy composition. The solidus temperatures for different compositions lie upon the solidus curves 213a and 213b, which also are collinear for some of their extent with the eutectic line (i.e., the horizontal tie line at the eutectic temperature 204). For example, for a composition in a eutectic alloy system with a very high fraction of material A (as indicated by a dashed vertical line 210), the composition may have a solidus temperature 212 somewhat above the eutectic temperature 204, and a liquidus temperature 214 at the highest melting temperature for the composition. The composition may have a working temperature range 208 including a range of temperatures above a lowest melting temperature (e.g., where the entire system becomes solid) and below a highest melting temperature (e.g., where the entire system becomes liquid) where the composition, or a corresponding metallic build material includes solid and liquid phases in a combination providing a variable, temperature-dependent viscosity and rheological behavior suitable for extrusion. This working temperature range 208 will vary by composition and alloying elements, but may be adapted for a wide range of metal alloys for use in a fused filament fabrication process or the like as contemplated herein.

The metal alloy composition just described is one instance of a MBMP material of a general class of materials that are suitable for use with the present teachings hereof.

It should be understood that whenever alloy systems are discussed which have two constituents, that is, binary alloy systems, the same concepts will apply to alloy systems with three, four, and any number of constituents. As an example, a quaternary system can also have a eutectic composition.

Another instance of suitable MBMP materials may include compositions within a peritectic alloy system. A composition within a peritectic alloy system may also have a working temperature range with a multi-phase state suitable for use in a fused filament fabrication process.

Generally, a suitable MBMP material alloy system may contain more than one eutectic or more than one peritectic, as well as both eutectics and peritectics, all of which may provide a multi-phase state with a rheology suitable for extrusion. For example, the Al—Cu phase diagram (not reproduced herein) has both a eutectic and a peritectic. In particular, the presence of intermediate phases and intermetallic compounds can greatly increase the complexity of metal alloy phase diagrams, resulting in multiple regions within the phase diagram where at least one liquid phase and at least one solid phase coexist in equilibrium. In such systems, there may be a wide range of alloy compositions exhibiting a working temperature range with a multi-phase state suitable for use as a metallic build material in a fused filament fabrication process. All of the foregoing are instances of suitable MBMP materials.

Yet another instance of suitable MBMP materials are isomorphous alloy systems.

More generally, a chemical system may exhibit a multi-phase equilibrium between at least one solid and at least one liquid phase without exhibiting a eutectic or a peritectic phase behavior. The copper-gold system is an example. Such systems may still provide a working temperature range between a solidus and liquidus temperature with a rheology suitable for use in fused filament fabrication process as contemplated herein, and such systems are considered an instance of MBMP materials.

Another instance of suitable MBMP materials include metallic materials using a combination of a metallic base and a high temperature inert second phase, which may constitute a metallic multi-phase material which may be usefully deployed as a build material for fused filament fabrication. For example, U.S. application Ser. No. 15/059,256, filed on Mar. 2, 2016 and incorporated by reference herein in its entirety, describes a variety of such materials. Thus, one useful metallic build material contemplated herein includes a composite formed of a metallic base and a second phase.

Still more generally, describing the overall concept of MBMP materials, they may include any build material with metallic content that provides a useful working temperature range with rheological behavior suitable for heated extrusion and thus may be used as a metallic build material as contemplated herein. Examples have been given above. The limits of this window or range of working temperatures will depend on the type of material (e.g., metal alloy, metallic material with high temperature inert phase. For metal alloys, such as compositions in eutectic alloy systems, peritectic alloy systems and isomorphous alloy systems, the useful temperature range is typically between a solidus temperature and a liquidus temperature. In this context, the corresponding working temperature range is referred to for simplicity as a working temperature range between a lowest and highest melting temperature. For MBMP build materials with an inert high temperature second phase, the window may begin at any temperature above the melting temperature of the base metallic alloy, and may range up to any temperature where the second phase remains substantially inert within the mixture.

According to the foregoing, the term MBMP build material, as used herein, is intended to refer to any metal-containing build material, which may include elemental or alloyed metallic components, as well as compositions containing other non-metallic components, which may be added for any of a variety of mechanical, rheological, aesthetic, or other purposes. For non-limiting example, non-metallic strengtheners may be added to a metallic material.

Much of the discussion above has centered around metal alloy systems containing as few as two elements. The present teachings disclosed herein apply to metal alloy systems with any number of elements. Examples of commercial alloys which are relevant include the following: Zinc die-casting alloys such as Zamak 2, Zamak 3, Zamak 5, Zamak 7, ZA-8, ZA-12, ZA-27. Magnesium die casting alloys such as AZ91. Aluminum casting alloys such as A356, A357, A319, A360, A380. Aluminum wrought alloys such as 6061, 7075.

It is useful to return to a more detailed discussion of apparatus and methods used to treat and build objects with such build materials. FIG. 1 is a block diagram of an additive manufacturing system. In general, the additive manufacturing system may include a three-dimensional printer 101 (or simply printer 101) that deposits a metal, metal alloy, metal composite or the like using fused filament fabrication or any similar process. In general, the printer 101 may include one or more build materials 102 which are propelled by one or more drive systems 104 and heated to an extrudable state by one or more heating systems 106, and then extruded through one or more nozzles 110. By concurrently controlling robotics 108 to position the nozzle(s) along an extrusion path relative to a build platform unit 114, an object 112 and support structure 117 may be fabricated on the build platform unit 114 which may be situated within a build chamber 116. In general, a control system 118 may manage operation of the printer 101 to fabricate the object 112 according to a three-dimensional model using a fused filament fabrication process or the like.

The build material 102 may be provided in a variety of form factors including, without limitation, any of the form factors described herein or in materials incorporated by reference herein. The build material 102 may be provided, for example, from a hermetically sealed container or the like (e.g., to mitigate oxidation and other undesirable reactions with the environment), as a continuous feed (e.g., a wire). In one aspect, two build materials 102 may be used concurrently, e.g., through two different nozzles.

The build material 102 may include a metal wire, such as a wire with a diameter of approximately 80 μm, 90 μm, 100 μm, 0.5 mm, 1 mm, 1.25 mm, 1.5 mm, 1.75 mm, 2 mm, 2.25 mm, 2.5 mm, 3 mm, or any other suitable diameter.

The build material 102 may have any shape or size suitable for extrusion in a fused filament fabrication process.

A printer 101 disclosed herein may include a first nozzle 110 for extruding a first material. The printer 101 may also include a second nozzle for extruding a second material with the same or different mechanical, functional, or aesthetic properties useful for fabricating a multi-material object.

A drive system 104 may include any suitable gears, rollers, compression pistons, or the like for continuous or indexed feeding of the build material 102 into the heating system 106.

The heating system 106 may employ a variety of techniques to heat a metallic build material to a temperature within a working temperature range suitable for extrusion. For fused filament fabrication systems as contemplated herein, the working temperature range is more generally a range of temperatures where a build material exhibits rheological behavior suitable for fused filament fabrication or a similar extrusion-based process. These behaviors are generally appreciated for, e.g., thermoplastics such as ABS or PLA used in fused deposition modeling, however many metallic build materials have similarly suitable behavior, albeit many with greater forces and higher temperatures, for heating, deformation and flow through a nozzle so that they can be deposited onto an object with a force and at a temperature to fuse to an underlying layer. Among other things, this requires a plasticity at elevated temperatures that can be propelled through a nozzle for deposition (at time scales suitable for three-dimensional printing), and a rigidity at lower temperatures that can be used to transfer force downstream in a feed path to a nozzle bore or reservoir where the build material can be heated into a flowable state and forced out of a nozzle.

Any heating system 106 or combination of heating systems suitable for maintaining a corresponding working temperature range in the build material 102 where and as needed to drive the build material 102 to and through the nozzle 110 may be suitably employed as a heating system 106 as contemplated herein. In one aspect, electrical techniques such as inductive or resistive heating may be usefully applied to heat the build material 102. Thus, for example, the heating system 106 may be an inductive heating system or a resistive heating system configured to electrically heat a chamber around the build material 102 to a temperature within the working temperature range, or this may include a heating system such as an inductive heating system or a resistive heating system configured to directly heat the material itself through an application of electrical energy. Particularly useful nozzle apparati and methods of using such nozzles having mechanisms for both heating (adding thermal power to) the nozzle outlet and cooling its inlet, and even the opposite (providing thermal power to the inlet and removing thermal power from (cooling) the nozzle outlet are disclosed in U.S. patent application Ser. No. 16/035,296, mentioned and incorporated by reference, above.

The robotics 108 may include any robotic components or systems suitable for moving the nozzles 110 in a three-dimensional path relative to the build platform unit 114 while extruding build material 102 to fabricate the object 112 and support structure 117 from the build material 102 according to a computerized model of the object. A variety of robotics systems are known in the art and suitable for use as the robotics 108 contemplated herein. For example, the robotics 108 may include a Cartesian coordinate robot or x-y-z robotic system employing a number of linear controls to move independently in the x-axis, the y-axis, and the z-axis within the build chamber 116. Delta robots may also or instead be usefully employed. Other configurations such as double or triple delta robots can increase range of motion using multiple linkages. More generally, any robotics suitable for controlled positioning of a nozzle 110 relative to the build platform unit 114 may be usefully employed, including any mechanism or combination of mechanisms suitable for actuation, manipulation, locomotion, and the like within the build chamber 116.

The robotics 108 may position the nozzle 110 relative to the build platform unit 114 by controlling movement of one or more of the nozzle 110 and the build platform unit 114. The object 112 may be any object suitable for fabrication using the techniques contemplated herein. The build platform unit 114 may include any surface or substance suitable for receiving deposited metal or other materials from the nozzles 110.

The build platform unit 114 may be movable within the build chamber 116, e.g., by a positioning assembly (e.g., the same robotics 108 that position the nozzle 110 or different robotics). For example, the build platform unit 114 may be movable along a z-axis (e.g., up and down—toward and away from the nozzle 110), or along an x-y plane (e.g., side to side, for instance in a pattern that forms the tool path or that works in conjunction with movement of the nozzle 110 to form the tool path for fabricating the object 112 and support structure 117), or some combination of these. In an aspect, the build platform unit 114 is rotatable. The build platform unit 114 may include a temperature control system for maintaining or adjusting a temperature of at least a portion of the build platform unit 114.

In general, an optional build chamber 116 houses the build platform unit 114 and the nozzle 110, and maintains a build environment suitable for fabricating the object 112 and support structure 117 on the build platform unit 114 from the build material 102.

The printer 101 may include a vacuum pump 124 coupled to the build chamber 116 and operable to create a vacuum within the build chamber 116. The build chamber 116 may form an environmentally sealed chamber so that it can be evacuated with the vacuum pump 124 or any similar device in order to provide a vacuum environment for fabrication. The environmentally sealed build chamber 116 can be purged of oxygen and water, or filled with one or more inert gases in a controlled manner to provide a stable build environment. Thus, for example, the build chamber 116 may be substantially filled with one or more inert gases such as argon or any other gases that do not interact significantly with heated metallic build materials 102 used by the printer 101.

In general, a control system 118 may include a controller or the like configured to control operation of the printer 101. The control system 118 may be operable to control the components of the additive manufacturing system 100, such as the nozzle 110, the build platform unit 114, the robotics 108, the various temperature and pressure control systems, and any other components of the additive manufacturing system 100 described herein to fabricate the object 112 and support structure 117 from the build material 102 according to build path instructions 122 based on a three-dimensional model or any other computerized model describing the object 112 or objects to be fabricated. The control system 118 may include any combination of software and/or processing circuitry suitable for controlling the various components of the additive manufacturing system 100 described herein including without limitation microprocessors, microcontrollers, application-specific integrated circuits, programmable gate arrays, and any other digital and/or analog components, as well as combinations of the foregoing, along with inputs and outputs for transceiving control signals, drive signals, power signals, sensor signals, and the like.

In general, build path instructions 122 or other computerized model of the object 112 may be stored in a database 120 such as a local memory of a computing device used as the control system 118, or a remote database accessible through a server or other remote resource, or in any other computer-readable medium accessible to the control system 118. The control system 118 may retrieve particular build path instructions 122 in response to user input, and generate machine-ready instructions for execution by the printer 101 to fabricate the corresponding object 112.

In operation, to prepare for the additive manufacturing of an object 112, a design for the object 112 may first be provided to a computing device 164. The design may include build path instructions 122 of a three-dimensional model included in a CAD file or the like.

The computing device 164 may include the control system 118 as described herein or a component of the control system 118. The computing device 164 may also or instead supplement or be provided in lieu of the control system 118. Thus, unless explicitly stated to the contrary or otherwise clear from the context, any of the functions of the computing device 164 may be performed by the control system 118 and vice-versa. In another aspect, the computing device 164 is in communication with or otherwise coupled to the control system 118, e.g., through a network 160.

The computing device 164 (and the control system 118) may include a processor 166 and a memory 168 to perform the functions and processing tasks related to management of the additive manufacturing system 100 as described herein.

One or more ultrasound transducers 130 or similar vibration components may be usefully deployed at a variety of locations within the printer 101. As discussed below, a nozzle service region 188 is spaced away from the object build region 186 where the object is fabricated. The nozzle service region is where at least some service operations are conducted. It may include one or more cameras 150 or other optical or visual devices, other sensors 170, waste material receptacles 128, additional heating and cooling apparatus 126, as well as any items or supplies that may be used to service the nozzle and other parts of the device.

FIG. 3 shows an extruder 300 for a three-dimensional printer. In general, the extruder 300 may include a nozzle 302, a nozzle bore 304, a heating system 320, and a drive system 308 such as any of the systems described herein, or any other devices or combination of devices suitable for a printer that fabricates an object from a computerized model using a fused filament fabrication process and a metallic build material as contemplated herein. In general, the extruder 300 may receive a build material 310 from a source 312, such as any of the build materials and sources described herein, and advance the build material 310 along a feed path (indicated generally by an arrow 314) toward an opening 316 of the nozzle 302 for deposition on a build platform unit 318 or other suitable surface. The term build material is used herein interchangeably to refer to metallic build material, species and combinations of metallic build materials, or any other build materials. As such, references to build material 310 should be understood to include metallic build materials, or multi-phase metallic build materials or any of the other build material or combination of build materials described herein, under specific conditions, unless a more specific meaning is provided or otherwise clear from the context.

The nozzle 302 may be any nozzle suitable for the temperatures and mechanical forces required for the build material 310. For extrusion of metallic build materials, portions of the nozzle 302 (and the nozzle bore 304) may be formed of high-temperature materials such as sapphire, alumina, aluminum nitride, graphite, boron nitride or quartz, which provide a substantial margin of safety for system components.

The nozzle bore 304 may be any chamber or the like suitable for heating the build material 310, and may include an inlet 305 to receive a build material 310 from the source 312. The nozzle 302 may also include an outlet 316 that provides an exit path for the build material 310 to exit the nozzle bore 304 along the feed path 314 where, for example, the build material 310 may be deposited in a segment (also referred to herein and in the industry as a road, bead, or line) on the build platform unit 318. The inside dimensions of the nozzle bore may be larger than the outside dimensions of the incoming build material, and thus could be said to have some amount of clearance or extra volume with respect the build material. It should also be noted that the nozzle bore may take a wide array of geometries and cross-sections and need not be uniform along its length. For example, it may include diverging sections, converging sections, straight sections, and non-cylindrical sections. Subsequent layers of lines are deposited upon an earlier layer 392. The layer presently being deposited as the top layer 390 has an exposed upper surface 372, upon which the next to be deposited layer will be deposited.

The heating system 320 may employ any of the heating devices or techniques described herein. It will be understood that the heating system 320 may also or instead be configured to provide additional thermal control, such as by locally heating the build material 310 where it exits the nozzle 302 or fuses with a second layer 392 of previously deposited material, or by heating a build chamber or other build environment where the nozzle 302 is fabricating an object. The temperature of the nozzle 302 may be measured with one or more temperature measuring devices 340. Optionally, forced gas cooling 362 may be applied near the nozzle inlet. An auxiliary heater (not shown) may be provided relatively close to the inlet 305, for times when it may be desired to add thermal power to the nozzle near to the inlet.

The drive system 308 may be any drive system operable to mechanically engage the build material 310 in solid form and advance the build material 310 from the source 312 into the nozzle bore 304 with sufficient force to extrude the build material 310, while at a temperature within the working temperature range, through the opening 316 in the nozzle 302. In general, the drive system 308 may engage the build material 310 while at a temperature below the working temperature range, e.g., in solid form, or at a temperature below a bottom of the working temperature range where the build material 310 is more pliable but still sufficiently rigid to support extrusion loads and translate a driving force from the drive system 308 through the build material 310 to extrude the heated build material in the nozzle bore 304.

A sensor, such as a load cell 328, or a torque sensor 309, may be coupled to the drive system 308, to sense the load on the drive system. This can be useful, for instance, to determine whether any blockages or other impediments to driving the build material may be occurring. In one embodiment, the drive assembly 306 is allowed to pivot about point 311 and the load cell 328 provides the reaction force. Additionally, a sensor 329 can be provided that measures the force exerted by build material 310 within and exiting the nozzle outlet 316 upon the nozzle 302. For instance, a load cell 329 can measure the force of the build material pushing on the entire nozzle 302. In one embodiment, the nozzle assembly is allowed to pivot about point 313 and the load cell 329 provides the reaction force.

Alternatively, a torque sensor can be included within the drive mechanism to sense the torque on the driving apparatus, such as wheels or gears. The current that any motor used to power the drive system is related to the force that the drive system encounters. Therefore, the current drawn by the drive motor 344 can be monitored via sensor 342, with an increase in current indicating an increase in power needed to drive the build material into the nozzle inlet and thereby inferring the extrusion force. The motor 344 is mechanically engaged with build material drive system 308.

As discussed below, the forces measured by the various sensors can be compared, or combined, or otherwise analyzed to assess whether or not a flow artifact is present or forming.

The extruder 300 may also include a controller 330, for controlling various components of the extruder, including the cooling 362, heating 320 and taking various inputs including temperatures 340 and forces 328 329.

Unlike thermoplastics conventionally used in fused filament fabrication, metallic build materials are highly thermally conductive. As a result, high nozzle temperatures can contribute to elevated temperatures in the drive system 308. Thus, in one aspect, a lower limit of the working temperature range for the nozzle bore 304 and nozzle 302 may be any temperature within the temperature ranges described above that is also above a temperature of the build material 310 where it engages the drive system 308, thus providing a first temperature range for driving the build material 310 and a second temperature range greater than the first temperature range for extruding the build material 310. Or stated alternatively and consistent with the previously discussed working temperature ranges, the build material 310 may typically be maintained within the working temperature range while extruding and below the working temperature range while engaged with the drive system 308, however, in some embodiments the build material 310 may be maintained within the working temperature when engaged with the drive system 308 and when subsequently extruded from by the nozzle 302. All such temperature profiles consistent with extrusion of metallic build materials as contemplated herein may be suitably employed. While illustrated as a gear, it will be understood that the drive system 308 may include any of the drive chain components described herein, and the build material 310 may be in any suitable, corresponding form factor.

As noted above, a printer may include two or more nozzles and extruders for supplying multiple build and support materials or the like. Thus, the extruder 300 may be a second extruder for extruding a supplemental build material.

In FFF an object is constructed in a largely layer-wise fashion from a series of path segments, which may be straight, or curved or both. A build layer may be planar, or non-planar (i.e., be represented by a surface and have curvature). A build layer may extend over the whole projection of an object build region, but it need not.

The term extrudate refers to the build material that is exiting the nozzle. In FFF, an extrudate is deposited from a nozzle onto a surface, generally referred to herein as an underlayer. The extrudate becomes the overlayer, and an interface is formed between the underlayer and the overlayer. The degree of adhesion, which is also referred to as the strength of adhesion, refers to the strength of the bond formed at this interface (i.e., bond strength per unit of interface area), through the various mechanisms described herein, which may be quantified by many mechanical tests such as shear strength, peel strength, tensile strength, or fracture toughness tests, for example. Roughly speaking, the maximum bond strength would be that of the weakest build material present near the interface (i.e., the interface is as strong as the bulk). The minimum strength would be zero, where the overlayer is not bonded to the underlayer at all.

In many 3D printing techniques, in order to realize objects with complex geometries, temporary structures, known as supports, are required. In the following, all material deposited for the creation of an object will be referred to as the build. A build comprises generally the object or objects themselves and any support structures. Support structures enable the creation of objects with overhanging geometry, which otherwise would not be printable. For example, a particular printing process may be able to print an inclined wall up to a maximum angle of inclination from the vertical, however for inclinations beyond this angle some form of support structure must be employed to prevent the printed wall from distorting, slumping, or otherwise failing to have the desired shape. In the case of FFF, the supports should act against the self-weight of the printed material as well as forces exerted by the nozzle on the build during printing. In some cases, supports may additionally play a role in the thermal management of the build during the printing process.

Supports play a crucial role while the object is being printed, but their useful role may also extend into additional processing steps, so called post-processing steps, which may be required to achieve the desired object geometry and material properties. Such additional processes may include, but are not limited to high temperature steps. While supports may be important to fabricate objects with complex geometries, they eventually need to be removed from the printed object, before it can be used and are therefore, in a sense, temporary.

Depending on the nature of the supports, a variety of strategies may be employed to remove them. It is highly desirable to be able to remove supports without using excessive force or secondary processes.

Breakaway supports are fabricated from the same material as the build material. Such supports may be found in Fused Filament Fabrication objects with polymeric build materials. The low strength of polymeric build materials conventionally used in FFF allows for the removal of support structures via manual means, including hand tools, such as pliers, chisels, cutters and knives. Removing supports in this fashion may leave witness marks and blemishes on surfaces of the final printed object, which may require additional post-printing processing to blend or mask.

In MBMP FFF it may be desirable for both the object and the support structure to be made from a MBMP build material. The support may be printed from the same MBMP build material that is used to print the object, or it may be printed from a different MBMP build material. Due to the higher strength of the metallic build materials contemplated herein, removing metallic breakaway support structures may require additional equipment or steps, such as metal cutting using abrasive cut-off wheels, saws, or milling, or wire electrical discharge machining. These processes can be labor-intensive and may require a different setup, fixtures or tooling for every bespoke geometry. Therefore, it is desirable to have a method to more easily remove support structures from the printed object for FFF of MBMP build materials. To accomplish this, the adhesion at the interface between an object and its support should preferably be sufficiently low with respect to the strength of the printed object to allow for the easy separation of the support from the object. The interface between the support structure and the object is of paramount importance for printing the object, as will be discussed below, as well as facilitating the removal of the support structures, whether one or more MBMP materials are used. Control over the degree of adhesion at the object and support interface is thus very important to realize a successful support strategy.

Adhesion between two layers of material reflects the propensity of the two materials to bond to each other at their common interface. Adhesion at such interfaces is achieved through intermolecular interactions. In general, one can distinguish between several mechanisms that give rise to adhesion. These are micromechanical, dispersive, chemical and diffusive adhesion.

In general, only a small portion of the extrudate and the underlayer (only the material nearest the interface) play a significant role in the adhesion process. The length scale over which the aforementioned adhesion mechanisms occur is typically small with respect to the printed layer thickness, and is localized to the interface.

Micromechanical adhesion refers to microscopic interlocking of the surface of one material with the surface of the other. For instance, if one of the materials is in a liquid state, it may fill in voids or pores on the surface of the other material, such that after the liquid's solidification, the two materials are mechanically interlocked at the interface. In dispersive adhesion, the surfaces of two materials adhere to each other due to the presence of short range attractive intermolecular forces, such as the van der Waals forces. In chemical adhesion, materials that react with each other and form compounds, may form strong covalent, ionic or metallic bonds with each other. Diffusive adhesion is caused by diffusion at the interface between two materials. This mechanism is often prevalent in materials that are miscible with each other and contain mobile species. Diffusive adhesion often occurs in combination with chemical adhesion, such that the diffused species form chemical bonds between the two surfaces.

Which of these adhesion mechanisms occurs between two layers depends on the interfacial chemistry, i.e., the chemical composition of the layers, as well as any other chemical species that may be present at the interface. In many cases, a combination of some or all of the above described mechanisms may give rise to adhesion at a specific interface. For instance, in many cases, materials that can form compounds and undergo chemical adhesion may also be miscible and diffuse into each other, giving rise to diffusive adhesion. Also, at solid/liquid interfaces, after full solidification, chemical, diffusive and dispersive adhesion may often be accompanied by micromechanical adhesion.

In addition to the interface chemistry, the interface temperature and structure can play a critical role. Interface chemistry strongly affects thermally activated intermolecular processes, such as interdiffusion between the two layers. In many cases the time-temperature history of the interface may determine how strongly the two surfaces adhere to each other. The higher the temperature and the longer the dwell time at that temperature the further the intermolecular processes can progress and thus the higher the degree of adhesion at the interface.

The interface temperature may also determine the state of matter in which a material is present at the interface. For instance, if the interface temperature exceeds the melting temperature of one of the materials present at the interface, this material may transition from a solid to a liquid state. In particular, for MBMP materials, such as for instance the multi-phase metal alloys discussed herein, varying the interface temperature within the working temperature range of these materials may strongly change the amount of liquid present at the interface. Since diffusion coefficients are typically orders of magnitude higher in liquids, as compared to in solids, diffusive adhesion processes may be greatly accelerated if at least one of the two materials present at an interface is in a liquid state. Beyond the higher propensity for diffusive adhesion, the presence of liquid at an interface may also help to increase the contact area at the interface, as described below.

Adhesion depends on intermolecular interactions between the two materials and thus can only occur where they are in intimate contact and form an interface. Properties impacting the physical structure of the interface, such as the roughness, porosity and surface tension of the two neighboring surfaces can significantly influence the contact area between the two surfaces and thus their degree of adhesion. A higher contact area between two surfaces will typically result in stronger adhesion and vice versa. For solid-solid interfaces a low surface roughness is critical for achieving a high contact area. For solid-liquid interfaces, the surface tensions and thus the degree of wetting of the liquid on the solid determines the contact area between the two.

Many metals undergo oxidation at their exposed surfaces in oxygen rich environments. Aluminum and magnesium, for example, readily oxidize in ambient conditions. The oxide creation process may occur very rapidly, and usually occurs at a higher rate with increasing temperatures and oxygen concentrations. The created oxides themselves may be viewed as inert because their melting temperatures are typically far above the working temperature range of the build material. For two metallic surfaces to chemically bond to each other, any oxide at the surface must be at least partially broken. In the context of FFF with MBMP, this is accomplished by subjecting the oxide surface to large deformations and strains. These occur when the extrudate heats up the underlayer, due to the dissimilar coefficients of thermal expansion of the oxide and the base material. This dissimilarity may cause the oxide skin to fracture. Furthermore, the pressure imparted by the nozzle on the build and the shear stress caused by the extrudate as it is deposited atop the underlayer may further cause the oxide skin to fracture. Printing in a dry, inert atmosphere environment (e.g., argon, nitrogen, or carbon dioxide, or vacuum) may dramatically slow the rate at which the metallic build materials oxidize and thereby facilitate the fracturing of the oxide skin. Fracturing of the oxide surface is beneficial to the creation of strong adhesion at the interface as more of the MBMP material will reach the interface surface.

During printing, the object is fabricated according to a set of build instructions, based on a digital model of the object, by moving one or more extrusion nozzles in a three-dimensional build path relative to the build platform assembly while extruding build material. As material is extruded from the extrusion nozzle, the nozzle land physically contacts the extruded material and defines the height of the extruded line. Due to this mechanical contact, the moving nozzle exerts a force on the extruded line. This force has a component parallel to the direction of travel of the nozzle, which acts to move the extruded material with respect to the previous layer of deposited material. The adhesion at the object and support interface therefore needs to be sufficiently high to counteract this parallel force and to achieve good registration between extruded lines and the support.

The method present teachings of tunable layer adhesion presented herein are selective. By this it is meant that they need not be applied across the whole interface between two build layers, and may instead be applied to only a subset of a layer interface or portions of a layer interface. Thus, complex freeform geometries can be created.

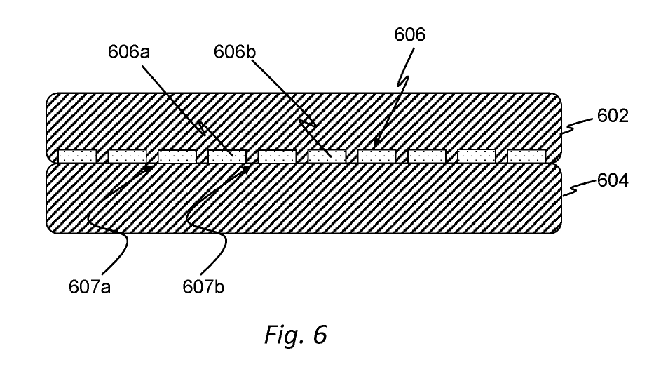

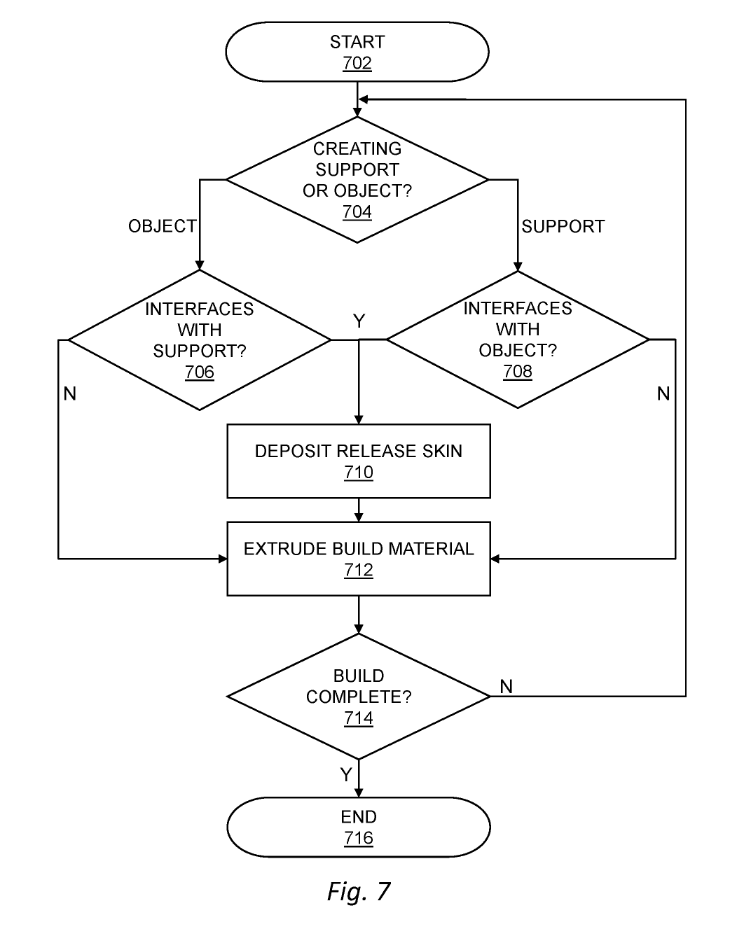

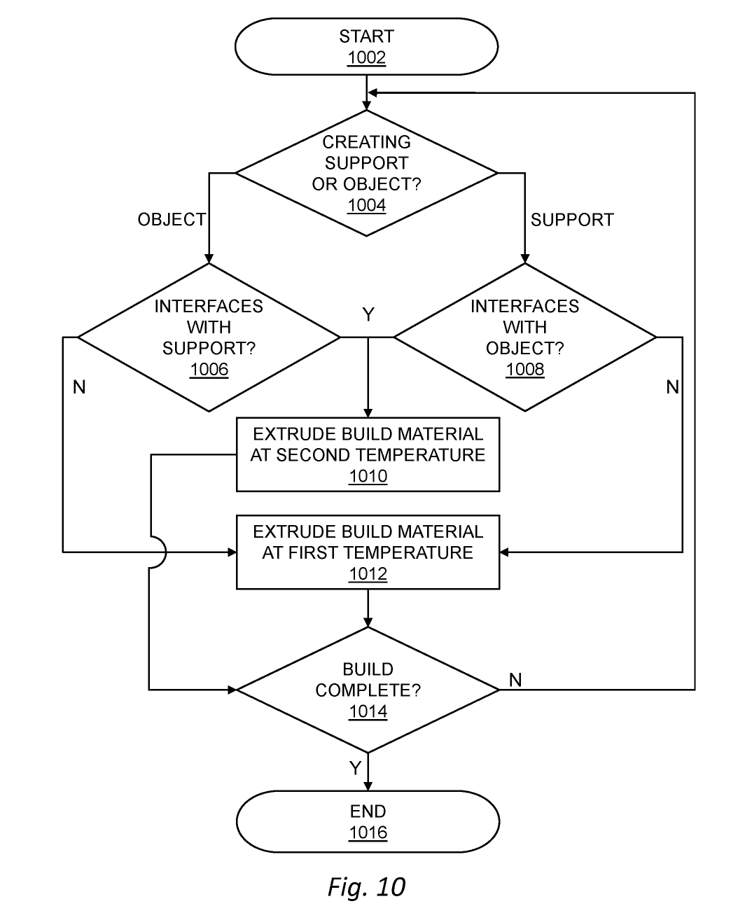

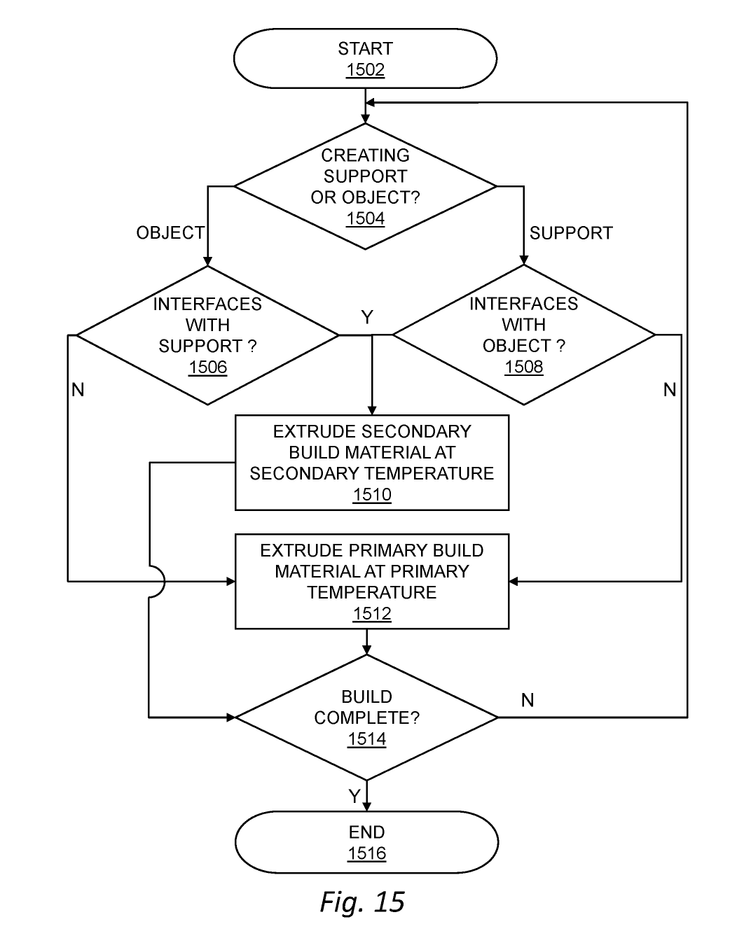

In the following, three different methods are discussed to control adhesion at the object and support interface: providing a thin release skin (shown schematically in FIG. 7); extruding a single build material at different temperatures (shown schematically in FIG. 10); and extruding different build materials at different temperatures (shown schematically in FIG. 15).

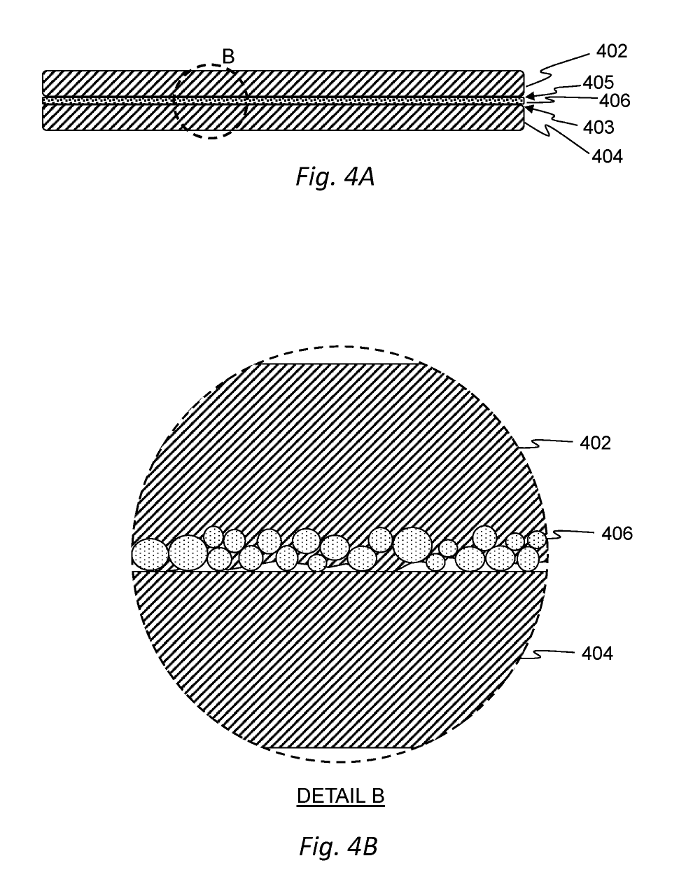

One method to control the adhesion at the interface between the object and the support is to provide a thin skin of additional material between the two. A schematic example of an inert powder release skin is shown in FIG. 4A. There is an interface 403 between the underlayer 404 and the skin 406, and another interface 405 between the skin 406 and the overlayer 402. Depending on the permeability of the skin to the multi-phase extrudate at deposition, there may also be an interface between the extrudate and the underlayer. Adhesion at all of these interfaces follows the principles discussed above. For the purposes of discussion, further reference to the interface involving a release skin will be taken to mean the interface between the extrudate and the underlayer (i.e., the combination of all the potential interfaces described above). As used herein, the term release skin is used to refer to a collection of non-contiguous powder particles which may or may not be embedded in a matrix of a carrier material. This release skin may conform to a portion of an underlying surface and cover an area fraction of the portion of this surface. Generally, a release skin is deposited upon the underlayer and the extrudate is deposited upon the release skin, and the release skin will form part of the build until it is removed.

With refence to FIG. 4A, the build geometry extends into the page and the depositions occurred in a left-to-right or right-to-left fashion. First, the underlayer 404 of build material was deposited. Then, the release skin powder 406 was deposited on top of the underlayer. Lastly, the overlayer 402 of build material was deposited. In this way, the degree of adhesion between the overlayer and the underlayer is lesser due to the presence of the release skin. The overlayer may then be more easily separated from the underlayer during post-processing. FIG. 4B is a detail view of the powder particles present at the interface between the build material layers. Depending on the local rheological properties of the extrudate in the moments immediately following deposition, the extrudate may partially or fully flow into the porosity of the powder network. In this way the effective area of contact between the underlayer and the overlayer may be tuned and reduced from the nominal case.

Selectively depositing release skins may create weak adhesion between the printed object and its support structures, thereby facilitating their removal during post-processing. More generally, the presence of a release skin limits the adhesion at the interface between the extrudate and the underlayer. A release skin may include an inert solid phase material in the form of a powder, grains, particulates, pellets, crystals, flakes or other morphology. The term powder is used herein to refer to all of these materials.

Many materials may be suitable as release skins. Ceramic particles (such as aluminum oxide, aluminum nitride, silicon dioxide, silicon carbide, boron nitride, mullite, machinable glass ceramics and zirconia), graphite, molybdenum disulfide and other inorganics (such as carbonates, sulfides, salts, and metal halides) may be used. To be considered inert, the release skin material should not meaningfully react with or mix with the build material over the temperatures and timescales of the FFF process.

In one embodiment, graphite powder is used for a release skin for processing aluminum alloys or zinc aluminum alloys. Carbon shows low solubility in these systems within their respective working temperature range.

A release skin may function due to several mechanisms. Firstly, a layer of powder (e.g., the release skin) on top of the underlayer, reduces the contact area between the extrudate and the underlayer, as compared to without the release skin. The amount of contact which it makes is related to the effective area fraction of the release skin. The effective area fraction is proportional to the apparent packing density of the powder and the thickness of the skin. The release skin may present an impermeable barrier to the extrudate or a partially permeable layer or a selectively permeable barrier (e.g., allowing the liquid phase of the extrudate through but not the solid particles, due to their size). Due to the limited permeability, the adhesion between the extrudate and the underlayer is less than it would be without the skin.

Furthermore, the inert solids included in the release skin have their own thermal mass. The extrudate is the source of the bonding energy. By virtue of the extrudate being in intimate contact with the release skin and having to heat it from, nominally, the underlayer temperature to the extrusion temperature, some thermal energy must be spent here, which might have otherwise gone to increasing the temperature of the underlayer. Here, it has been assumed the release skin temperature has time to approximately equilibrate with the cooler underlayer temperature (e.g., the build temperature) after its deposition. The reduced underlayer temperature reduces the liquid fraction at the interface and thereby reduces the layer adhesion.

Moreover, the inert solids that make up the release skin may pose as a thermally insulating boundary between the underlayer and the extrudate. In the steady state, the presence of a low thermal conductivity layer may result in a temperature gradient across it. The insulating effect further protects the underlayer from reaching the extrusion temperature, reducing the liquid fraction at the interface and thereby reducing adhesion. Because the layer bonding process is dynamic, it is appropriate to look at the thermal diffusivity. Many solid particles exhibit relatively low thermal diffusivities and may slow the rate of temperature increase at the interface by allowing more time for thermal energy from the extrudate to be dissipated through loss mechanisms (radiative and convective losses to the environment) as opposed to being conducted to the interface. In this way, the temperature versus time evolution of the interface differs from the case without a release skin and is characterized by lower interface temperatures compared to the case with no release skin. These factors further reduce the effective liquid fraction achieved at the interface thereby reducing the layer adhesion and facilitating release.

Additionally, some powders that make up the release skin may have intentionally mismatched coefficients of thermal expansion (CTE) with respect to the build material. The build is nominally at a temperature during printing, which is referred to herein as the build temperature. Upon cooling of the build from the build temperature to near room temperature, this CTE disparity may be exploited to facilitate support removal. If the powder has a net higher coefficient of thermal expansion as compared to the build material, then the powder will tend to contract more volumetrically than the build material and attempt to pull away from the build material upon cooling. This can lead to areas of stress concentrations, or voids in the vicinity of the interface. For example, the linear CTE of a release skin of sodium chloride and a build material of 2024 aluminum alloy between 500° C. and 20° C. may be taken to be approximately 50 μstrain/° C. and 23 μstrain/° C., respectively. This yields a difference of linear CTEs of positive 27 μstrain/° C. between the powder and the object. The resulting stresses here may be quite large and may overcome the weaker local adhesion at the object and support interface, thereby facilitating the removal of the support structures.

Conversely, if the release skin powder has a net lower coefficient of thermal expansion as compared to the build material, such as for a release skin of graphite release skin with a CTE that may be taken to be approximately 5 μstrain/° C., then the powder will tend to contract less, volumetrically, than the build material and there will be an attempt to expand the release layer relative to the build material. Using the same temperature difference and build material as in the above example, yields a CTE difference of negative 18 μstrain/° C. Similarly to above, the resulting stresses here may also be quite large and may overcome the weaker local adhesion at the object and support interface, thereby facilitating the removal of the support structures.

Thus, with a mismatch in CTE between the powder release skin and the build material of either orientation (release skin layer or build material having a relatively larger CTE), stresses may arise that may facilitate removal of a support structure.

Some types of powder materials included in the release skin may be easily removed from the printed object via a batch process. For example, if the powder has solubility or reactivity in a solvent in which the build material does not, then the powder interfaces may be dissolved or removed via submerging the object into a bath of the solvent, greatly facilitating support structure removal. For example, if sodium chloride is used as the release skin for an object built from aluminum alloy or a zinc-aluminum die casting alloy build material, then the powder of the release skin may be dissolved by placing the build in a container of water. The water may be heated or agitated to accelerate the dissolving process.

The powder may also be deposited with a carrier fluid. The carrier fluid may be a liquid, exhibit liquid-like behavior, or it may be gaseous. Preferably, the carrier fluid is temperature-stable at the printing temperatures. For example, an extreme high temperature tolerant grease may be used. Greases and lubricants are available with continuous service temperature above 400° C. and even above 800° C. are available.

In another embodiment, the carrier is a polymer with extremely high heat resistance. A composite of an inert powder as discussed above and such a heat resistant polymer carrier material may be extruded in a FFF manner. The polymer should be relatively temperature stable at the processing temperature. For the extrusion of zinc-aluminum alloys, this may be approximately 360-430° C. Additionally, the polymer may be broken down or dissolved with a solvent, such as acetone, to facilitate the removal of support structures during post-processing.

The powder may form a suspension, colloid, dispersion, sol-gel or mixture with the carrier fluid. Powders entrained in a carrier fluid may be deposited onto the underlayer through nozzles, syringe pumps, positive displacement pumps, pneumatic dispensers or the like.

The powder may also be deposited without the aid of a carrier fluid. In this case, the powder should have adequate flow characteristics through the deposition mechanisms to prevent clogging, jamming, and intermittent flow. The deposition assembly or portions of the deposition assembly may be agitated to aid in this regard.

The powder may be deposited with the assistance of an electrostatic charge. The printed object may be grounded, while the powder particles are charged as they leave a nozzle, helping them to stick to the underlayer surface. A gas carrier may aid powder deposition.

The powder may be deposited via a hopper, nozzle, and knife gate valve. FIG. 5 schematically illustrates such an apparatus and method for depositing the inert solid powder as the release skin. The land 512 of the nozzle 506 may act as a doctor blade or provide a levelling function to the powder layer, allowing defining the powder layer thickness, as set by the spacing between the nozzle land 512 and the underlayer substrate 508. A hopper 502 stores the powder 504 and presents it to the nozzle 506. Gravity causes the powder to fall downwards towards the underlayer 508. A knife gate valve 510 allows for the flow of powder to be stopped and started selectively as the powder deposition nozzle traverses with respect to the object underlayer 508. When the knife gate 510 is in its open position, the powder may exit the nozzle. The land 512 of the nozzle may serve to doctor blade or level the surface of the powder and control the thickness of the release skin. The assembly may be agitated by a rotating eccentric 514, ultrasonic transducer or the like, to improve fluidity of the powder. In another embodiment, an auger-like screw meters the powder and causes it to flow.

The powder size distribution may be selected on the basis of flowability, apparent density, or other requirements. For example, a bimodal powder size distribution may produce higher apparent densities than a monomodal distribution. The selection of powder shape, size, size distribution, morphology, deposition technique and deposition speed may be used to tailor the apparent density and thickness of the release skin, thereby affecting the adhesion between the underlayer and the extrudate, as discussed above.

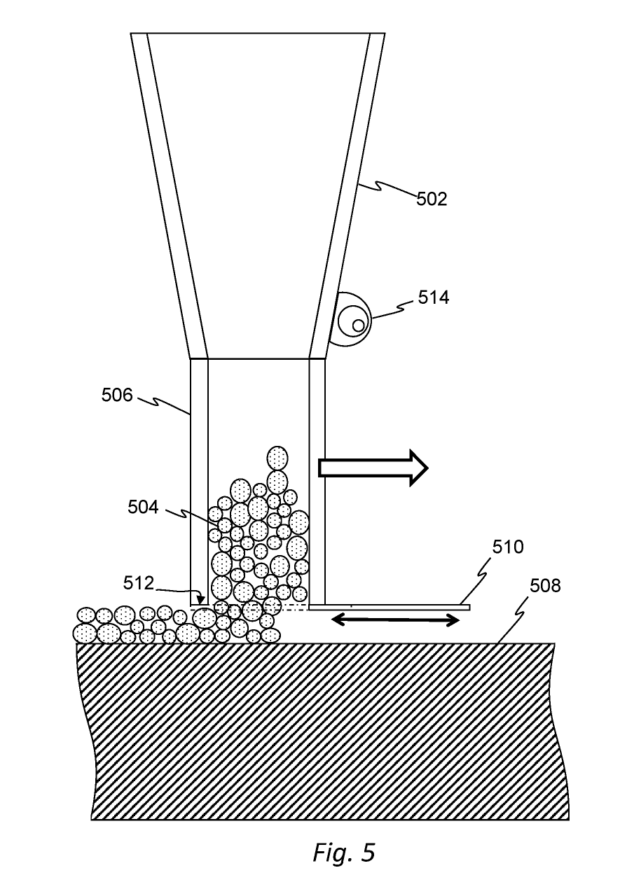

The release skins may be deposited in a spatially interrupted fashion, whereby only portions of the extrudate bond normally to the underlayer. FIG. 6 shows the result of the deposition of an interrupted track of interface skin. The built geometry extends into the page and the depositions occurred in a left-to-right or right-to-left fashion. First, an underlayer of build material 604 was deposited. Then, a release skin powder 606 was deposited on top. The release skin layer is not continuous, but rather was deposited in shorter segments 606a, 606b, etc. Lastly, an overlayer of build material 602 was deposited. Here, the overlayer 602 has relatively weaker adhesion to the underlayer 604 in locations where the inert powder release skin segments 606a, 606b, etc. have been deposited, as compared to the other regions. The regions 607a, 607b, etc., between these skin segments, in which the upper layer 602 is in direct contact with the underlayer 604, have essentially normal adhesion. The net degree of adhesion between the overlayer and the underlayer depends on the summation of the strength of adhesion in the regions where there is powder, and the normal regions. The spacing between, as well as the size and shape of the regions 606 with release skin may be varied. By the appropriate selection of this geometry, combined with the lesser degree of adhesion in the areas covered by release skin (as previously discussed), tunable layer adhesion may be achieved. The significantly reduced extent of normally bonded portion in such an interrupted release skin case may afford an interface with weaker adhesion than would an interface between two normal layers of build material thereby facilitating detaching an overlayer from an underlayer. However, such an interface with an interrupted release skin will likely have stronger adhesion than would an interface with a continuous release skin.

FIG. 7 shows generally the steps taken to fabricate an object via FFF that has support structures where release skins are provided at the interface between the support and the object. Providing a release skin contributes to the adhesive character at the interface where it is present. The build material is provided to the nozzle and extruder assembly to be extruded at an operating temperature onto the underlayer as the nozzle moves relative to the object being created.

To start 702, a series of decisions can be taken to determine the correct operating temperature. The first decision 704 is whether the upcoming extrudate will be used to create support geometry or object geometry. If object geometry is to be printed, the method branches to determine 706 whether the region to be printed interfaces with support geometry. Conversely, if the object/support decision 704 returns that support geometry is to be printed, the next decision 708 is whether the region to be printed interfaces with object geometry. In either case, if the answer is Yes, then a release skin should be deposited 710 at the interface atop the underlayer. Subsequently, build material should be deposited 712 in this region. Returning to consideration of the decisions whether the object or support interfaces with its respective opposite (706 and 708) In either case, if the answer is No, then the printer should deposit build material 712 normally. A next decision considers 714 whether the build is complete. As long as the build is not complete, this decision tree beginning with step 704 is continuously reevaluated. If the build complete determination 714 results in a yes/complete, the evaluation ends 716. In this way the interface adhesion between the object and the support is selectively tuned, by selectively depositing release skin when a support portion is deposited upon an object portion, and when an object portion is deposited upon a support portion.

There are many possibilities for the exact sequencing of the deposition of the release skin with respect to the fabrication of the object. For example, all the release skin needed between printed layers may be deposited before printing the overlayer. Alternatively, if the release skin is deposited before the build material is deposited, in the direction of travel of the build material nozzle, deposition of the release skin may occur nearly simultaneously with the deposition of the upper layer, but with each segment of release skin being deposited just before depositing the adjacent and following segment of build overlayer.

Additionally, it is possible to make deliberately weaker interfaces within the support structure itself using the same release skin method as described above. In this way, the support structures may be fabricated to be friable (e.g., may be break into multiple pieces during the post-processing step where the support structure is separated from the object). The deposition of a release skin at a support-support interface is analogous to the previously discussed object-support interfaces, as the support structure may be fabricated from MBMP material. The support material may be the same MBMP material as the object. Friable supports may be beneficial in cases where the support structure may not have a clear projection to the exterior of the build (e.g., is locked) and may not be otherwise removed, or near delicate object features (for example, thin, high aspect ratio protrusions).

The release skin has finite volume, which may lead to propagation or accumulation of geometric build errors in the vertical direction of the part (the direction that is potentially increased by addition of the release skin) if left unaddressed. One approach is to make the thickness of the release skin small with respect to the layer height of the build material. Preferably, the skin thickness is less than 1/10^{th} of the layer height. In this way, the cumulative stacking error in the vertical direction of the build may be kept small. Another approach is to adjust the deposition parameters of the extrudate printed atop a release skin to account for the finite thickness of the skin (e.g., via volumetric compensation). The powder size should be selected appropriately to produce release skins of the desired thickness. For example, to produce a release skin that is 1/10^{th} of the nominal build layer height of 0.5 mm, then the powder particles must be smaller than 50 μm.

The extrudate should have greater affinity to the combination of the release skin and the underlayer than to the exterior surfaces of the extrusion nozzle. In this way, beading or balling of the extrudate on the nozzle tip is mitigated.

It has been mentioned above that three different methods are discussed herein to control the degree of adhesion at the object and support interface: providing a thin release skin, discussed above; extruding a build material at different temperatures, which is discussed immediately following (shown schematically in FIG. 10); and extruding different build materials (at different temperatures), which will be discussed further below (shown schematically in FIG. 15).

Turning now to a discussion of using different temperatures to control adhesion at the object and support interface, as discussed above, adhesion at the interface between two materials in FFF in general is very sensitive to the time-temperature history of the interface, and even more so at the interface between MBMP materials. This temperature sensitivity can be used to control the adhesion. With many MBMP materials, such as multi-phase metal alloys, the liquid fraction present in the material is very sensitive to temperature, within their working temperature range. Since diffusion coefficients are typically orders of magnitude higher in liquids, as compared to in solids, diffusive adhesion processes may be greatly accelerated if at least one of the two materials present at an interface is in a liquid state or if a larger amount of liquid is present at the interface. Moreover, the presence of liquid at the interface may also increase the area of intimate contact between the two materials and thus promote other adhesion mechanisms, such as micromechanical adhesion.

Due to the thermally activated nature of many adhesion mechanisms, the highest temperature periods of the time-temperature history of the interface will predominantly determine the degree of adhesion at an interface. For a FFF process, this highest temperature period occurs during and immediately following the extrusion of new material on top of a previously extruded underlayer. During this temperature period, the temperature of the interface between these two layers is a result of thermal equilibration between the newly deposited layer and the underlayer (and the remainder of the build). Here the initial temperature of the extruded build material is largely determined by the operating temperature of the extrusion nozzle, and the initial temperature of the underlayer is largely determined by the temperature of the build platform unit and the environmental temperature.

This thermal equilibration process may be fairly complicated. Solutions for the interface of two semi-infinite bodies at isothermal temperatures that are brought into contact with one another are known. However, due to the complex temperature dependency of the apparent specific heat, density, and thermal conductivities of the multi-phase materials in question, combined with the dynamic nature of the printing process, such an analysis is not trivial. The problem is further complicated by the generally unknown geometry of the build and extrudate, which would require treatment on a case by case basis. The combination of these effects severely complicates a general analysis of the interface temperature. For the purpose of FFF with MBMP build materials, some simplifying assumptions may be made to facilitate the following discussion and arrive at useful guidelines for material and operating temperature selection. For instance, the initial temperature of the extruded build material is approximately given by the operating temperature of the extrusion nozzle. Moreover, the temperature of the build and thus the temperature of the underlayer is usually lower than the temperature of the extruded material. Also, the difference between the temperature of the underlayer and the initial temperature of the extruded material is, in many cases, relatively small, because the build is often kept at a temperature below, but close to, the lower end of the working temperature range of the MBMP build material. Therefore, the operating temperature of the extrusion nozzle may serve as a useful proxy for the initial temperature at the interface. The term initial interface temperature as used herein refers to the temperature of the interface during and immediately following the deposition of build material on top of an underlayer. It is further assumed that during the same time period at least the portions of the underlayer and the overlayer closest to the interface take on this initial interface temperature and exhibit a corresponding liquid fraction. During this time period, the liquid fraction at the interface is then given by a combination of the liquid fraction of the underlayer and the liquid fraction of the overlayer, adjacent to the interface. It is understood that the time-temperature evolution of the interface is much more complex than described above and that the interface and the underlayer will never reach the initial temperature of the extrudate, nor the operating temperature of the extrusion nozzle. The above simplifying assumptions are used only for the sake of simplifying the discussion (that would likely be intractable without these simplifying assumptions) and to establish useful guidelines for the control of interface adhesion.

In addition to the temperature setting of the build platform, the build environment and the extrusion nozzle, other print parameters, such as the print speed and the volumetric deposition rate, may also have an influence on the temperature and thus the degree of adhesion at the interface between succeeding layers of MBMP material, albeit typically to a lesser degree.

While the initial interface temperature can be controlled by changing the build platform temperature, environment temperature and nozzle temperature, changing the nozzle temperature is most suited to be used for this purpose. The nozzle temperature can be changed quickly, compared to that of the build platform and environmental temperature, because the heat capacity of the nozzle is typically much smaller than that of the build platform combined with the build. Changing the nozzle temperature also allows for local control of the initial interface temperature (e.g., achieving different initial interface temperatures in different regions of the printed object), whereas changing the build platform temperature and environmental temperature typically impacts the temperature of the printed geometry more globally.

In addition to the extrusion temperature, the composition of the MBMP materials may be used to control adhesion at the interface between two layers of MBMP material. The liquid fraction present in many MBMP materials, such as multi-phase metal alloys, at a given temperature depends strongly on the composition of the material. Therefore, controlling the composition of the two layers allows control over the amount of liquid present at the interface and thus the degree of adhesion. It is important to note that the composition of the two layers may be the same, but may also be advantageously chosen to be different from each other, as will be discussed in more detail later.

The liquid fraction at the interface is given by a combination of the liquid fraction in the portions of the overlayer and underlayer closest to the interface. It is worth noting however, that the liquid fraction at the interface may in some cases be higher than expected from liquid fraction versus temperature curves, because solid-liquid separation in the build material may result in an elevated liquid fraction at the surface of extruded build material compared to its interior.

As discussed earlier, for the purpose of FFF printing of an object with support structures, it is desirable to be able to realize two different degrees of adhesion: relatively weak adhesion at the support to object interface and very good adhesion at the layer to layer interfaces of the object itself. By taking advantage of the two degrees of freedom discussed above, namely the MBMP material composition and the operating temperature of the extrusion nozzle, a range of strategies can be applied to achieve these degrees of adhesion.

In a first temperature-based strategy, a single MBMP material is used for object and support, such that all interfaces are interfaces between two layers of the same material. The operating temperature of the extrusion nozzle is then adjusted to achieve the two different degrees of adhesion at the interface. Instead of operating a single extrusion nozzle at multiple operating temperatures, multiple extrusion nozzles may be operated at an operating temperature each, to control interface adhesion.

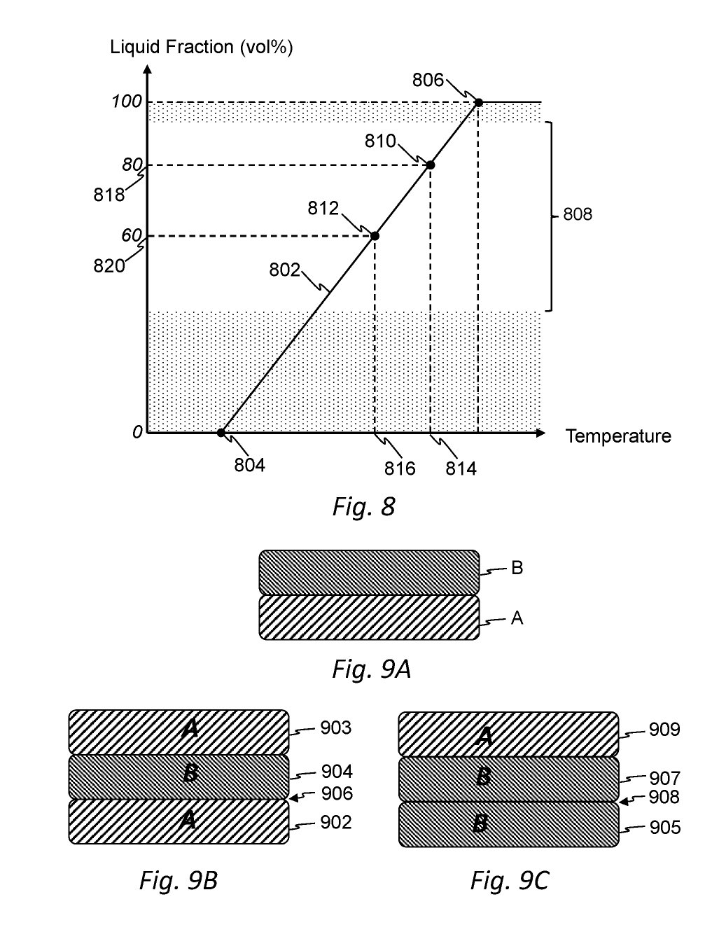

FIG. 8 shows schematically an example of a simplified liquid fraction versus temperature plot for a multi-phase metal alloy. Liquid fraction is shown on the vertical axis and temperature is sown on the horizontal axis. For a given alloy composition, this data can be determined from the equilibrium phase diagram of the alloy family, from thermodynamic calculations, or by using experimental techniques, such as differential scanning calorimetry. Here liquid fraction refers to the volume fraction of the material that is in a liquid state. As mentioned above, for many MBMP materials, the change in molar volume upon melting is relatively small and liquid fractions based on the molar fraction of the material that is in a liquid state, may also be used.

From FIG. 8, two temperatures can be selected, such that the liquid fraction of the MBMP material at the first temperature is higher than at the second temperature. From an adhesion control perspective, the two extreme points on the liquid fraction curve 802 corresponding to 0% liquid fraction 804 and 100% liquid fraction 806 might appear most beneficial to achieve the two desired adhesion states. But considerations other than layer adhesion need to be considered. Foremost, at the operating temperature of the nozzle, the build material needs to exhibit rheological behavior suitable for extrusion and deposition. This limits the range of available liquid fractions for the purpose of adhesion control to range of liquid fractions 808 (approximately 40 vol % to 95 vol %).

Depending on the nature of the MBMP material, other considerations may also have to be taken. For instance, towards the lower end of the liquid fraction range (e.g., the higher end of the solid fraction range) described above, the extrusion nozzle may have an intolerably high propensity for clogging because solid material is more likely to build up in the nozzle. This behavior might further limit the range of available liquid fractions for adhesion control.

It is important to note that it is the effective liquid fraction and not necessarily the equilibrium liquid fraction of the material that is decisive for its rheological and adhesive behavior. The effective liquid fraction, i.e., the volume fraction of the material that is in a liquid state and exists exterior and between the fraction that is solid phase, may in some cases be lower than the equilibrium liquid fraction discussed above. For example, liquid may form or become trapped within a solid particle, thereby making it ineffective for the purposes of rheological behavior and interface adhesion. The temperature and material selection rules discussed here may thus have to be based on the effective liquid fraction in cases in which the effective liquid fraction is substantially lower than the equilibrium liquid fraction at a given temperature.

If a liquid fraction range 808 has been established within which the above mentioned extrudability requirements are satisfied, a first point 810 and a second point 812 can be selected on the liquid fraction curve 802. The first point 810 corresponding to a first operating temperature 814 and the second point 812 corresponding to a second operating temperature 816 can be selected. They are selected such that the liquid fraction 818 of the MBMP material at the first temperature 814 is higher than the liquid fraction 820 at the second temperature 816. The second temperature 816 preferably corresponds to a liquid fraction 820 towards the lower end of the accessible liquid fraction range 808. The first temperature 814 preferably corresponds to a liquid fraction 818 towards the higher end of the accessible liquid fraction range 808. In a non-limiting example, a first temperature corresponding to a liquid fraction of 80 vol % may be chosen and a second temperature corresponding to a liquid fraction of 60 vol % may be chosen.

There are four different interface combinations that can be realized by using two different operating temperatures. To discuss these, the following terminology is used. A layer extruded at the first temperature (e.g., at a higher liquid fraction) is referred to as a A-type layer and a layer extruded at the second temperature (e.g., at a lower liquid fraction) is referred to as a B-type layer. Based on this terminology, the following four interface combinations can be achieved and are discussed below: A-A, B-B, A-B and B-A. Here, the nomenclature implies sequential deposition of the layers in question, as read from left to right. For instance, for a B-A interface such as the one shown in FIG. 9A, the B layer was deposited first and the A layer was deposited second.

For this discussion it is assumed that a sufficiently long time passes between the deposition of the first layer and the deposition of the second layer. By sufficiently long, it is meant that the temperature of the first layer has equilibrated with the portion of the printed object printed before the second layer is deposited. It is further assumed that, as discussed above, the operating temperature of the nozzle is a good proxy for the initial interface temperature and that the portions of the underlayer and overlayer adjacent to the interface take on this initial interface temperature and exhibit a corresponding liquid fraction. The liquid fraction at the interface is then given by a combination of this liquid fraction of the underlayer and the overlayer.

At an A-A interface, (of two layers of the same MBMP material) the upper A layer is extruded at the first temperature, resulting in the relatively higher liquid fraction of the extruded material, the relatively higher initial interface temperature and thus the relatively higher liquid fraction in the portion of the previously printed A underlayer adjacent to the interface. The resulting higher liquid fraction at the interface can result in relatively strong adhesion for instance via chemical or diffusive adhesion.

At a B-B interface (of two layers of the same MBMP material), the upper B layer is extruded at the second temperature, resulting in a lower liquid fraction of the extruded material, a lower initial interface temperature and thus a lower liquid fraction in the portion of the underlayer adjacent to the interface. The resulting lower liquid fraction at the interface may limit chemical and diffusive adhesion processes and result in weaker adhesion relying largely on micromechanical adhesion processes.

At a B-A interface (of two layers of the same MBMP material), the situation is equivalent to the one discussed for the A-A interface and can produce strong adhesion. The upper, A layer, is extruded at the first temperature, resulting in a relatively higher liquid fraction of the extruded material, a relatively higher initial interface temperature and thus a relatively higher liquid fraction in the portion of the previously printed B underlayer adjacent to the interface.

At an A-B interface (of two layers of the same MBMP material) the situation is equivalent to the B-B interface discussed above and can result in weak adhesion. The upper, B layer, is extruded at the second temperature, resulting in a lower liquid fraction of the extruded material, a lower initial interface temperature and thus a lower liquid fraction in the portion of the underlayer adjacent to the interface. The resulting lower liquid fraction at the interface may limit chemical and diffusive adhesion processes and result in weaker adhesion relying largely on micromechanical adhesion processes.

Based on the four cases analyzed above, it can be seen that by using a single MBMP build material extruded at two different operating temperatures, the desired relatively weak and strong interface adhesion states can be achieved. A-A and B-A interfaces can exhibit relatively strong adhesion, whereas B-B and A-B interfaces can exhibit relatively weak adhesion.

These two kinds of interfaces can be advantageously employed to fabricate objects with easily removable breakaway supports. B-B and A-B interfaces may be used to provide the interface at which separation preferentially occurs. A layers, bonded by strong A-A interfaces, may mostly be relied on to build up the object and A and/or B layers may be used for the support structures. As discussed in more detail below, support structures made up of mostly B layers are friable (e.g., layers of support material can be separated from each other) due to the weak adhesion at the B-B interface. Similarly, support structures made up of a mixture of A and B layers are also friable (although to a lesser degree) due to weak adhesion at the A-B interface. In contrast, support structures made up of mostly A layers are not friable due to the strong adhesion at the A-A interface.

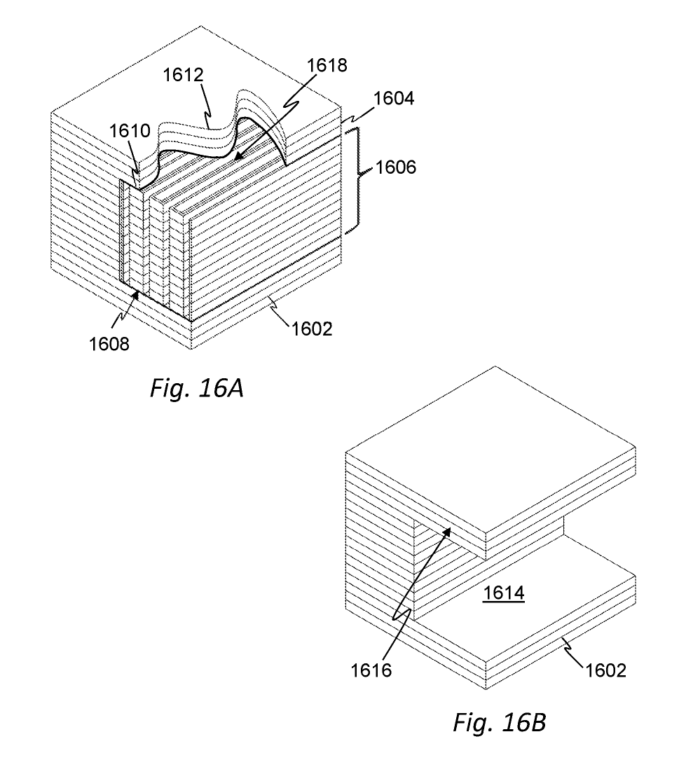

FIGS. 9B and 9C show two examples of possible layer sequences that can be used to realize objects with relatively easily removable breakaway supports. As shown in FIG. 9B, the support structure and object may mostly comprise A layers 902, 903 (one is shown for each) and B layers 904 (only one is shown) are used only in places where separable interfaces are desired. This will result in an A-B-A layer sequence in regions where separation is desired. Separation should preferentially occur at the interface 906 between the first A layer 902 and the B layer 904. After separation at the interface 906, the first A layer 902 will be part of the support and the B-A layers 904 and 903 will be part of the object or vice versa, for cases in which a support structure is located above an object structure (such as is shown in FIGS. 16A and 16B, discussed below, at the interface 1608, where the upper surface 1614 of the object 1602 is below the support structure 1606, which is primarily used to support the upper box portion of the object 1602, but is, nevertheless, in contact with an object portion below it, from which the support 1606 needs to be subsequently detached.) The B layer 904 can thus be thought of as a joining portion which joins the object and the support and which after separation will adhere either to the object or to the support, depending on the degree of adhesion to the either one.

FIG. 9C shows an alternative approach, where the support structure is mainly composed of B layers 905, 907 (two are shown) and the object is mainly composed of A layers 909 (only one is shown). This approach usually results in a B-B-A layer sequence in regions where separation is desired. Separation should preferentially occur at the interface 908 between the first B layer 905 and the second B layer 907. After separation at the interface 908, the first B layer 905 will be part of the support and the B-A layers 907 and 909, respectively, will be part of the object or vice versa. The B layer 907 can thus again be thought of as a joining portion which joins the object and the support and which after separation will adhere either to the object or to the support, depending on the degree of adhesion to either one. One possible advantage of the support structure mainly comprising B layers is that the support structures may easily be separated in their individual layers due to weak adhesion at the B-B interface. This may be particularly beneficial if support structures are required in narrow geometries such as for example in internal features of the object, where the support structure cannot be removed from the object in one piece. In this case extracting the support structure as a whole may be challenging or impossible, but breaking the support structure down to smaller pieces comprising individual layers may facilitate easy extraction.

The different degrees of adhesion resulting from the various sequences of A and B layers, and C and D layers, presented here in a vertical orientation may also apply in a horizontal sense (for example, when printing neighboring extruded lines within the same build layer). Thus, the sequence of the various types of depositions may be considered when determining the deposition order of lines within a build layer in order to realize the desired degree of adhesion between neighboring lines within a build layer.

In a variation on the two approaches discussed immediately above, the support structure may be mainly composed of alternating A and B layers and the object may be mainly composed of A layers. Depending on the termination layer of the support structure, this approach usually results in either an A-B-A or B-B-A layer sequence in regions where separations between support and object is desired. Separation in the A-B-A and B-B-A layer sequences occurs analogous to the above discussions. The primary difference between this approach and the two approaches discussed immediately above, is that while the support structure is still friable, it may no longer be separated into individual layers but rather into pairs of B-A layers. It is understood that analogous to using alternating A and B layers (resulting in A-B-A-B and so forth layer sequences), other layer sequences of A and B layers exhibiting different ratios of A and B layers may be employed. This includes for instance sequences such as for examples alternating A and B-B layers resulting in A-B-B-A-B-B and so forth layer sequences. Or any other type of A and B layer sequence.

FIG. 10 shows generally representative steps that can be taken to fabricate an object via FFF that has support structures where the adhesive aspects of the interface between the support and the object has been established via the deposition of build material at two different operating temperatures. Deposition of build material either occurs at a first operating temperature or a second operating temperature. The first operating temperature is higher than the second temperature and correspondingly the liquid fraction of the extruded build material is higher at the first operating temperature than at the second operating temperature. FIG. 10 depicts, schematically, in flow chart form, a basic method of the present teachings hereof in which both support portions and object portions are made predominantly of build material extruded at a first operating temperature, and build material extruded at a second operating temperature is used only at interfaces that are intended to be separable. The build material is provided to the nozzle and extruder assembly to be extruded at an operating temperature onto the underlayer as the nozzle moves relative to the object being created.

To start 1002, a series of decisions can be taken to determine the correct operating temperature. The first decision 1004 is whether the upcoming extrudate will be used to create support geometry or object geometry. If object geometry is to be printed, the method branches to determine 1006 whether the region to be printed interfaces with support geometry. Conversely, if the object/support decision 1004 returns that support geometry is to be printed, the next decision 1008 is whether the region to be printed interfaces with object geometry. In either case, if the answer is Yes, (which amounts to a result that an object is interfacing with a support), then the operating temperature is set to the second (relatively lower) operating temperature 1010. Further, in either case, if the answer is No, (which amounts to a result that the interface is between sequential like items: object to object or support to support) then the operating temperature is set 1012 to the first (relatively higher) operating temperature. A next decision considers 1014 whether the build is complete. As long as the build is not complete, this decision tree beginning with step 1004 is continuously reevaluated to determine the appropriate operating temperature. If the build complete determination 1014 results in a yes/complete, the evaluation ends 1016. In this way the interface adhesion between the object and the support is selectively tuned by selectively depositing layers at different temperatures, depending upon the desired fragility and integrity of interfaces of the layers being deposited.

There are numerous possible permutations of layer stacking order and combinations (especially in the support structure). The foregoing describes highly useful combinations, which serve to illustrate the basic principles of material and operating temperature choice. They are not meant to be limiting, and are provided as illustrations only.

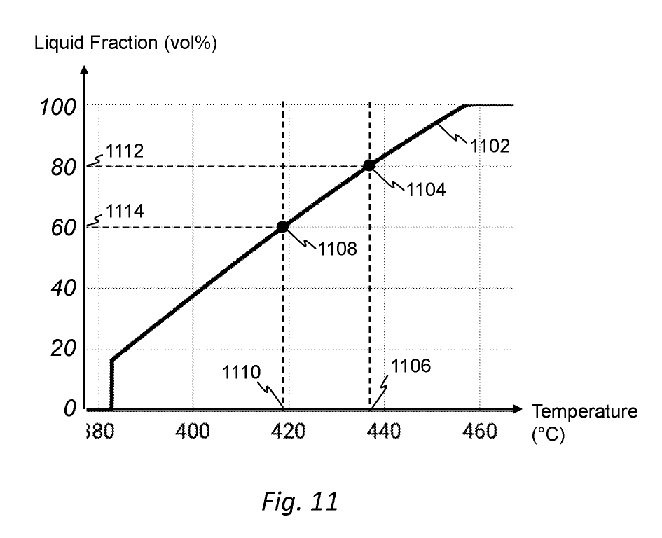

An example of a liquid fraction versus temperature curve for an actual suitable build material is shown in FIG. 11. The build material belongs to the binary zinc aluminum alloy family with a composition of 85 wt % zinc and 15 wt % aluminum and has a working temperature range suitable for heated extrusion. From the liquid fraction curve 1102, two points can be selected. A first point 1104 corresponding to a first (relatively higher) operating temperature 1106 of 437° C. and a second point 1108 corresponding to a second (relatively lower) operating temperature 1110 of 419° C. At the first operating temperature 1106, the build material is thus extruded at a liquid fraction 1112 of approximately 80 vol % and at the second operating temperature 1110 the build material is extruded at a liquid fraction 1114 of 60 vol %. Consider an example where an A layer refers to a layer deposited at the first temperature 1106 and a B layer refers to a layer deposited at a second temperature 1110. Based on these liquid fractions, it can be expected that the adhesion at A-A and B-A interfaces is much stronger than at B-B and A-B interfaces.

Build material can be deposited at two different temperatures using either a single nozzle, whose temperature is changed over time, or two different nozzles, each dedicated to a relatively narrow range of temperatures. It is important to note that if a single extrusion nozzle is used to extrude the build material at the first and the second operating temperature, care should be taken in the design of the build path. For example, considerations may be made for print interruptions that may arise from the finite time required to heat up or cool down the extrusion nozzle when switching between the two operating temperatures.

It has been mentioned above that three different methods are discussed herein to control adhesion at the object and support interface: providing a thin release skin, discussed above; extruding the same material at different temperatures, just discussed; and extruding different MBMP build materials, which will be discussed next (shown schematically in FIG. 15).

MBMP build materials with different composition may be employed to achieve the two desired adhesion states. It is important to note that in addition to having a different composition, the build materials may also be extruded at different operating temperatures, or both at the same operating temperature.

While the following discussion focuses on using two MBMP build materials, more than two MBMP build materials may in general be employed to achieve similar ends. Using two materials is however a useful embodiment, because a complexity penalty results from handling a multitude of build materials and extruders.

When two MBMP build materials are used, the build materials may be supplied in a variety of forms, such as for instance rod, wire or filament. The two build materials may be extruded from the same extrusion nozzle or from two different extrusion nozzles. If the two build materials are extruded from the same extrusion nozzle, care should be taken to minimize deposition of a mixture of the two materials (with unknown material properties) on the object and support structure. This can be achieved, for example, by purging the extrusion nozzle after switching between the build materials. If a single extrusion nozzle is used for the two build materials, care should be taken to adjust the build path and consider print interruptions that may arise from switching between build materials due to for instance the finite time required to switch between build materials.

One of the two build materials is typically what is referred to herein as a primary build material. A primary build material is a build material that makes up the majority of the built object. The primary build material and its operating temperature (i.e., the primary operating temperature) are typically selected based on design requirements for the printed object (such as its mechanical strength, density and service temperature) and constraints of the printing process (such as the suitability of the material for extrusion and its propensity for clogging). Based on the identity of the primary build material a temperature setting for the build platform unit and the environment are selected to achieve a desired temperature for the object printed on the build platform. Typically, a suitable build temperature is close to but below the lower end of the working temperature range of the primary build material.

Based on the identity of the primary material, a second MBMP build material, also referred to as a secondary material herein, and an operating temperature for the secondary build material also referred to as the secondary operating temperature herein, are selected. The secondary material and its operating temperature are typically selected for creating interfaces with weak and strong adhesion states, as necessary for printing objects with easily removable breakaway support structures.

The composition of the secondary build material is selected such that it has the potential to strongly adhere to the primary build material, for instance through chemical or diffusive adhesion. This is the case, for instance, if the secondary material is miscible with the primary material, or contains mobile species that form chemical bonds between the two surfaces.

The primary and secondary build materials also need to be compatible with each other, such that presence of the secondary material at an interface with the primary material does not unduly degrade the material properties of the primary build material. Some degradation in material properties may be tolerable, as long as it is limited to the immediate vicinity of the interface between the two materials, but does not meaningfully degrade the bulk material properties of the printed object. Such degradation may be as a result of preferential diffusion of a species from one side of the interface to the other, due to concentration gradients and solubility limits of some species in the bulk build materials.

These requirements can often be satisfied by choosing a secondary build material from the same alloy family as the primary build material. But other sets of two materials, not directly from the same alloy family (for instance aluminum magnesium alloys and aluminum silicon alloys) may also satisfy these requirements.

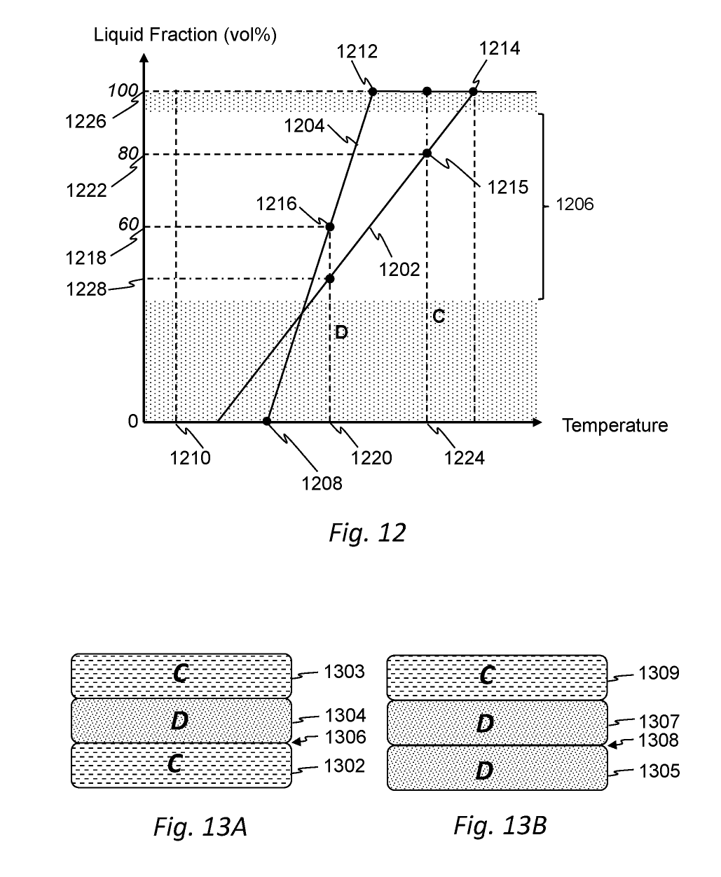

FIG. 12 shows an example of a simplified liquid fraction versus temperature plot for two multi-phase metal alloys with plot 1202 corresponding to a primary build material and plot 1204 corresponding to a secondary build material. For a given alloy composition, this data can be determined from the equilibrium phase diagram of the alloy family, from thermodynamic calculations, or by using experimental techniques such as differential scanning calorimetry. Here again, as above, liquid fraction refers to the volume fraction of the material which is in a liquid state. It is worth noting again, that for many MBMP materials, the change in molar volume upon melting is relatively small and therefore liquid fractions based on the molar fraction of the material that is in a liquid state, may instead be used.

Similar to the primary build material 1202, the secondary build material 1204 also needs to satisfy any requirements of the printing process. The secondary build material needs to exhibit a working temperature range with a rheology suitable for extrusion and preferably a low propensity for nozzle clogging. These requirements typically limit the range of available liquid fractions for the purpose of adhesion control to the range 1206 of liquid fractions (approximately 40 vol % to 95 vol %).

It is desirable to select a secondary material such that 1: the lower end of its working temperature range 1208 is higher than the build temperature 1210. 2: The upper end of the working temperature range 1212 of the secondary build material is preferentially lower than the upper end of the working temperature 1214 of the primary build material. 3: The secondary build material 1204 exhibits a working temperature range that is narrower than the working temperature range of the primary material. This range relationship means that, within their respective working temperature ranges, the secondary material 1204 exhibits a higher rate of change of its liquid fraction as a function of temperature than does the primary material 1202. More generally, the secondary material can be said to be more temperature sensitive than the primary material. This will be discussed in more detail below.

In order to maximize the difference in the degree of adhesion between the weak and strong adhesion states at interfaces involving one or both of either the primary and the secondary build material, it is beneficial to select an operating point 1215 on the liquid fraction curve of the primary material 1202 and an operating point 1216 on the liquid fraction curve of the secondary material 1204, such that the secondary material 1204 is extruded at a lower liquid fraction than the first material 1202 (e.g., the liquid fraction 1218 of the secondary build material at the secondary operating temperature 1220 (which may be the same or different from the primary operating temperature) is lower than the liquid fraction 1222 of the primary build material at the primary operating temperature 1224). This will be discussed in more detail below.

As a non-limiting example, a primary operating temperature 1224 corresponding to a liquid fraction 1222 of 80% in the primary build material 1202 and a secondary operating temperature 1220 corresponding to a liquid fraction 1218 of 60% in the secondary build material 1204 may be chosen.

As with extruding a single build material at different operating temperatures, discussed above, there are four different interface combinations that can be realized by extruding two build materials at different operating temperature. To discuss them, the following terminology is used. A layer of primary build material 1202 extruded at the primary operating temperature 1224 is referred to as a C-type layer (and also this temperature is annotated with a letter C on FIG. 12) and a layer of secondary build material 1204 extruded at the secondary operating temperature 1220 is referred to as a D-type layer (and also this temperature is annotated with a letter D on FIG. 12). Based on this terminology, the following four interface combination can be realized and are discussed below: C-C, D-D, C-D and D-C. As above, this nomenclature represents sequential deposition of the layers in question, as read from left to right. For instance, for a C-D interface, the C layer was deposited first and the D layer was deposited second.

For this discussion it is assumed that a sufficiently long time passes between the deposition of the first layer and the deposition of the second layer, which, as above, means that the temperature of the first layer has equilibrated with the remainder of the printed object before the second layer is deposited. It is further assumed that, as discussed above, the operating temperature of the nozzle is a good proxy for the initial interface temperature and that the portions of the underlayer and overlayer adjacent to the interface take on this initial interface temperature and exhibit a corresponding liquid fraction. The liquid fraction at the interface is then given by a combination of this liquid fraction of the underlayer and the overlayer.

At a symmetric interface (i.e., C-C or D-D interface), the composition of the overlayer and underlayer is the same, such that at a given interface temperature both layers should exhibit the same liquid fraction adjacent to the interface. Since a C (primary build material) layer is preferentially extruded at a higher liquid fraction than a D layer, the liquid fraction at a C-C interface is expected to be higher than the liquid fraction at a D-D interface. Provided that the difference in liquid fraction at the respective operating temperature is sufficiently large, the C-C interface may exhibit much stronger bonding than the D-D interface. The C-C interface may for instance exhibit strong chemical and/or diffusive adhesion, while at the D-D interface diffusive and chemical adhesion processes may occur at a much lower rate such that adhesion is largely based on micromechanical adhesion, which is weaker.

For symmetric interfaces, e.g., C-C and D-D interfaces, the situation is thus very similar to the one discussed above for a single MBMP material printed at two different operating temperatures because the composition of the underlayer and overlayer is the same and adhesion is largely dependent on the temperature at which the overlayer is deposited. For asymmetric interfaces, e.g., C-D or D-C interfaces, in which the overlayer and underlayer have different compositions, the situation can be very different from the single build material strategy discussed above. For instance, at a given initial interface temperature, the portion of the overlayer adjacent to the interface may exhibit a very different liquid fraction than the portion of the underlayer adjacent to the interface. The difference in liquid fraction is given by the difference in the rate of change of the liquid fraction as a function of temperature for the two build materials and the temperature difference between the primary operating temperature 1224 and secondary operating temperature 1220. The liquid fraction at an asymmetric interface may therefore be much higher or much lower than for the corresponding symmetric interfaces.

At a D-C interface, when the C layer is deposited on the D underlayer, the primary operating temperature 1224 can be used as a proxy for the initial interface temperature. As can be seen from FIG. 12, at the primary operating temperature 1224, the liquid fraction of the secondary build material 1204, which makes up the D layer, is higher than at the secondary operating temperature 1220 and may even be higher than the liquid fraction 1222 of the primary build material 1202, which makes up the C layer, at the primary operating temperature 1224. In some cases, the liquid fraction of the primary material, which makes up the D layer, may even reach 100%. The high liquid fraction in the portion of the D layer closest to the interface and the resulting high liquid fraction at the D-C interface may for instance result in strong chemical and/or diffusive adhesion that may even exceed the degree of adhesion at the C-C interface.

At a C-D interface, when the D layer is deposited on the C underlayer, the secondary operating temperature 1220 can be used as a proxy for the initial interface temperature. As can be seen from FIG. 12, at the secondary operating temperature 1220, the liquid fraction 1228 of the primary build material 1202, which makes up the C layer, is lower than the liquid fraction 1222 at the primary operating temperature and may be even lower than the liquid fraction 1218 of the secondary build material 1204, which makes up the D layer, at the secondary operating temperature 1220. In some cases, the liquid fraction of the primary material, which makes up the C layer, may even reach 0%. The low liquid fraction in the portion of the C layer closest to the interface and the resulting low liquid fraction at the C-D interface may limit the rate of diffusive and chemical adhesion processes to levels even lower than at the D-D interface, such that adhesion at the C-D interface may largely rely on weaker micromechanical adhesion.

While the amount of liquid present at the interface is an important indicator of the degree of adhesion at an interface, it is important to reiterate that adhesion at metal-metal interfaces is a complex process depending on a variety of factors such as the time-temperature-history of the interface and the composition of the materials involved. For some materials, significant diffusive and chemical adhesion may occur at the interface even if very little or no liquid is present, particularly if the initial interface temperature is high and if the materials involved exhibit high inter-diffusion coefficients.

Based on the four cases analyzed above, it can be seen that by using two MBMP build material extruded at different operating temperatures, the desired weak and strong adhesion states can be achieved. D-C and C-C interfaces can exhibit strong adhesion, with D-C interfaces potentially exhibiting the strongest adhesion. In contrast D-D and C-D interfaces can exhibit weak adhesion, with C-D interfaces potentially exhibiting the weakest adhesion.

An important advantage of using two MBMP build materials over using a single MBMP build material is that with two build materials it is possible to amplify a relatively smaller difference in liquid fraction during extrusion for the primary and secondary build material into a relatively larger difference in liquid fraction at their interface and thus a relatively larger difference in the degree of adhesion at their interface. Since extrusion at lower liquid fractions (e.g., higher solid fractions) is more prone to nozzle clogging, the ability to extrude both materials at a similar and high liquid fraction is very desirable to reduce the frequency of nozzle clogging.

The four kinds of interfaces discussed above can also be advantageously employed to fabricate objects with relatively easily removable breakaway supports. D-D and D-C interfaces may be used to provide the interface at which separation preferentially occurs, and C-C interfaces may mostly be relied on to build up the object, where interface separation is to be avoided.

FIGS. 13A and 13B show two examples of possible layer sequences that can be used to realize objects with relatively easily removable breakaway supports. As shown in FIG. 13A, the support structure and object may mostly be made from C layers 1302, 1303. D layers 1304 are used only in places where separable interfaces are desired. This will result in a C-D-C layer sequence in regions where separation is desired. Separation at the interface 1306 between a C 1302 and a D 1304 layer should preferentially occur between the first C layer 1302 and the D layer 1304. After separation at the interface 1306, the first C layer 1302 will become part of the support and the combined, still adhered D-C layers 1304 and 1303, will become part of the object, or vice versa. The D layer 1304 can thus be thought of as a joining portion which joins the object and the support, and which exhibits different degrees of adhesion to the object and to the support, such that after separation the D layer 1304 will adhere either to the object or to the support.

FIG. 13B shows an alternative approach, where the support structure is mainly composed of D layers 1305 and 1307. The object is mainly composed of C layers 1309. This approach usually results in a D-D-C layer sequence in regions where separation is desired. Separation at the interface 1308 should preferentially occur between the first D layer 1305 and the second D layer 1307. After separation, the first D layer 1305 will be part of the support and the D-C 1307 and 1309 layers will be part of the object, or vice versa. The D layer 1307 can thus again be thought of as a joining portion which joins the object and the support, and which exhibits different degrees of adhesion to the object and to the support, such that after separation the D layer 1307 will adhere either to the object or to the support. One possible advantage of a support structure mainly composed of D layers is that the support structure may easily be separated into individual layers due to the relatively weak adhesion at the D-D interfaces 1308. This may be particularly beneficial if support structures are required in narrow geometries.

In a variation on the two approaches discussed immediately above using two different types of build material, the support structure may be mainly composed of alternating C and D layers and the object may be mainly composed of C layers. Depending on the termination layer of the support structure, this approach usually results in either a C-D-C or D-D-C layer sequence in regions where separations is desired. Separation in the C-D-C and D-D-C layer sequences occurs analogous to the above discussions. The primary difference between this approach and the two approaches discussed immediately above, is that while the support structure is still friable, it may no longer be separated into individual layers but rather into pairs of D-C layers.

The above discussion focuses on simplified stacks of a few layers to discuss the ability to control adhesion at the interfaces between these layers through material and temperature selection. For simplicity, no specifications were made towards the spatial extent of the stacked layers within the layer plane. This should however not be interpreted as meaning that the stacked layers used for illustrative purposes above have an infinite extent, or span an entire build layer. In practice, these simplified layer stacks should be understood as a representation of a localized region of subsequent build layers within a build and do not necessarily correspond to the full extent of a layer of the printed object or support structure. For instance, the above discussed techniques for adhesion control can be used selectively (e.g., for only a fraction or localized region or regions of a layer in the build). Within a build, at different locations across each build layer, there may be different types of deposits (by type, it is meant a C-type, or a D-type, or an A-type or a B-type), and also on adjacent build layers, there will be other combinations of different types, and between build layers, there will be different interfaces having different adhesive strengths.

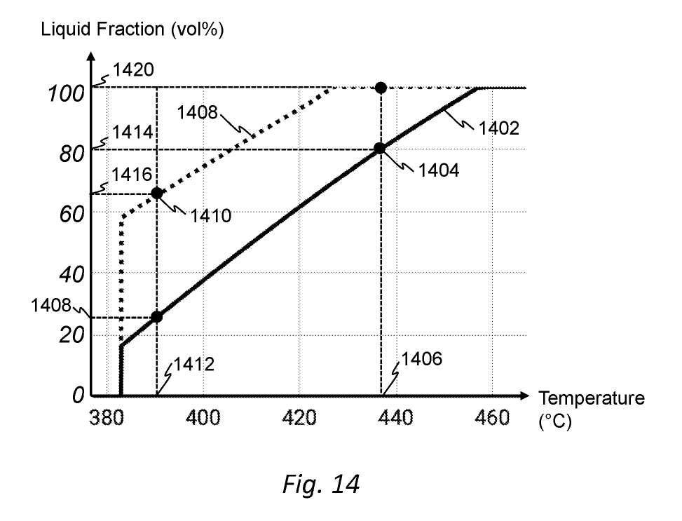

An example of a liquid fraction versus temperature curve for an actual suitable primary and secondary build material pair is shown schematically in FIG. 14. Both build materials are zinc-aluminum binary alloys. The primary build material 1402 has a composition of 85 wt % zinc and the secondary build material 1408 has a composition of 90 wt % zinc. From the liquid fraction curve of the primary material 1402, the primary operating point 1404 can be selected corresponding to a primary temperature 1406 of 437° C. And from the liquid fraction curve of the secondary material 1408 the secondary operating point 1410 can be selected corresponding to the secondary operating temperature 1412 of 392° C. The primary build material 1402 is thus extruded at a liquid fraction 1414 of approximately 80 vol % and the secondary build material 1408 is extruded at a liquid fraction 1416 of 65 vol %.

The liquid fraction 1418 of the primary build material 1402 at the secondary operating temperature 1412 is approximately 25 vol % and the liquid fraction 1420 of the secondary build material 1408 at the primary operating temperature 1406 is approximately 100 vol %. Based on these liquid fractions, it can be expected that the adhesion at a C-C and D-C interface is much stronger than at a D-D and C-D interface. Moreover, the adhesion at the D-C interface is expected to be the strongest and at the D-C interface adhesion is the weakest among the four kinds of interfaces. Here, a C layer refers to a layer of primary build material 1402 deposited at the primary operating temperature 1406 and a D layer refers to a layer of secondary build material 1408 deposited at the secondary operating temperature 1412.

It is important to note that the foregoing discussions of layer stacks and stacking sequences such as the two layer stack shown in FIG. 9A and the three layer stacks shown in FIGS. 13A and 13B as well as in FIGS. 9B and 9C, are focused only on the critical interfaces and the type of layers that make up an interface. Where the type of layer refers to the composition of the layers and the temperature at which they were deposited. While in the aforementioned figures, only the two layers making up an interface are shown, there can in general be numerous additional layers of the same type of layer as the layer adjacent to the interface, on either side of it. However, in some instances, such as the three layer stacks shown in FIGS. 13A, 13B, 9B and 9C, it may be the case that the intermediate layer would be only a single layer of one type but the layers bounding it on either side would be followed by many layers of the same type as the respective bounding layers. Therefore, an interface described here as an interface between a layer of one type and another layer of another type may in general be considered as an interface between a stack of one or more layers of one type and one or more layers of the other type.

FIG. 15 shows generally a series of steps that may be taken to fabricate an object via FFF. FIG. 15 depicts, schematically, in flow chart form, a basic method of the present teachings hereof in which both support portions and object portions are made predominantly of primary build material extruded at a primary operating temperature, and secondary build material extruded at a secondary operating temperature is used only at interfaces that are intended to be separable. The build has an object and support structures where the adhesive strength of an interface between the support and the object is established via the deposition of a primary and secondary build material. As described above in more detail, the primary build material is deposited at a primary operating temperature and the secondary build material is deposited at a secondary operating temperature. To start 1502, a series of queries can be taken to determine a correct build material. The first decision 1504 is whether the upcoming extrudate will be used to create support geometry or object geometry. If the query 1504 returns that object geometry is to be printed, the method branches to query 1506 and determines whether the region to be printed interfaces with support geometry. Conversely, if the query 1504 returns that support geometry is to be printed, the method branches to query 1508 to determine whether the region to be printed interfaces with object geometry. In either case of the queries 1506 and 1508, if the answer is Yes (which means that an interface between object and support portions of the build is to be created), then the secondary build material and the secondary operating temperature is used 1510. In either case, if the answer is No (which means that an interface within either an object portion or a support portion of the build is to be created), then the method branches from queries 1506 and 1508 to extrude 1512 primary build material at the primary operating temperature. A query 1514 considers whether the build is complete, and, if not, the method returns to the query 1504 and proceeds as above to determine the appropriate build material and operating temperature. If the build 1514 is complete, the evaluation ends 1516. In this way the interface adhesion between the object and the support is selectively tuned.

One advantage of both the single build material and two build material support strategies described herein is the high quality of the surfaces they may produce between the support structure and the object. These interfaces may separate without significant blemishes or witness marks.

There are numerous possible permutations of layer stacking order and combinations (especially in the support structure). The foregoing describes highly useful combinations, which serve to illustrate the basic principles of material and operating temperature choice. They are not meant to be limiting, and are provided as illustrations only.

The method steps in FIGS. 7, 10, and 15, which show the determination of deposition sequence for tunable adhesion between support structures and printed objects may be performed ahead of the deposition (e.g., in a computer program which prepares an instruction set for the fabrication of the object) or may be performed on the printer hardware itself (potentially superseding the instruction set).

There are object geometries for which it is desirable to tune the adhesion between adjacent layers of the object portion of the build (rather than between adjacent object and support layers). For example, when constructing a live hinge or flexural geometry, it is beneficial to have a stationary portion of the object and flexible elements, thereby permitting their relative movement. In this case, the relatively weak layer adhesion may be provided between the stationary and flexible element to permit their later partial separation. This specification of layer adhesion may be achieved by employing any of the layer adhesion control techniques described herein. Using an interface skin to control the interface adhesion however has the advantage that upon removal of the interface skin, there exists a gap between the stationary and flexible element, which affords additional clearance to permit the relative motion of the elements.

Another example would be printing geometries with high aspect ratio cuts. For example, a finned heat sink often has many thin protruding features with minimal spacing between them. If the spacing between features is smaller than the minimum layer thickness of the support structures but larger than the thickness of a release skin, a release skin may be deposited between adjacent fins. The release skin creates the desired spacing between the fins and may later be removed from the printed object.

An example of a simple print geometry is shown in FIG. 16A and FIG. 16B. The geometry is a block 1602 with a cutout, forming an overhanging region 1604. If printed in the depicted orientation (the build layers printed nominally in the horizontal plane), the overhang 1604 may require a temporary support structure 1606 during printing due to its self-weight and large unsupported span during its construction. Here, the support structure 1606 is not fully dense, but instead has a serpentine-shaped thin-walled pattern to use less material and reduce the printing time. The partial section view afforded by the cut 1612 is shown to more clearly illustrate this structure. The support structure has two interfaces with the build material. The first interface 1608 is between an upper surface 1614 of the object and the lower surface of the support. The second interface 1610 is between the upper surface 1618 of the support and a lower surface 1616 of the overhanging portion 1604 of the part. Here, the first (lowermost) layer of the support structure 1606 may be made from a MBMP material extruded at a low liquid fraction such that 1608 is a weak interface. Similarly, the first layer of the block 1602 right above the last (uppermost) layer of support structure 1606 may be made from MBMP build material extruded at a low liquid fraction such that the interface 1610 is weak. The remaining portions of the support structure 1606 may either be constructed from MBMP build material extruded at a high liquid fraction or at a low liquid fraction. The advantage of extruding MBMP material at a low liquid fraction being that the support structure is friable (e.g., can be broken down). Alternatively, both interfaces 1610 and 1608 may be formed via the application of a release skin at the interface. In this case, the support structure 1606 is constructed from the primary build material. Here, the aforementioned strategies to reduce the degree of interface adhesion between the object and the support need only be applied where such an interface exists. In this example, their spatial expanse is smaller than the extents of the object and are not applied over the entirety of a build layer.

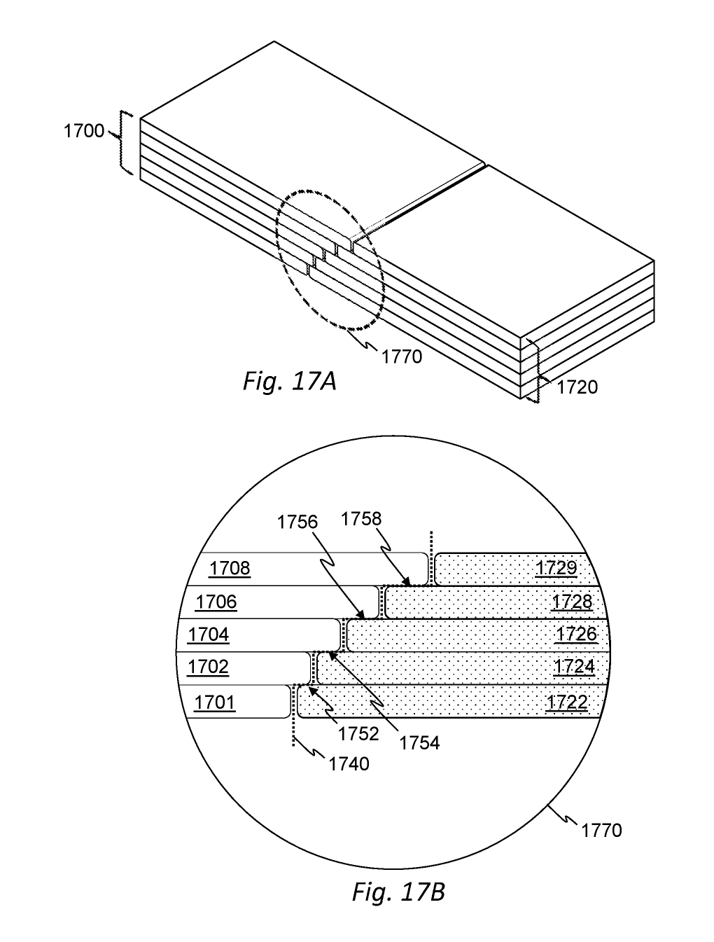

FIGS. 17A and 17B depict another example of a printed object and a support structure. FIG. 17A shows an isometric view of the object 1700 and the support structure 1720. FIG. 17B shows a detailed view of the build region with 2270 showing its layer-wise construction near an area where the object 1700 and the support structure 1720 meet. Here, the support structure 1720 has been hatched with a light dotted pattern to more clearly distinguish it from the object 1700. Specifically, the object comprises layers 1701, 1702, 1704, 1706 and 1708. The support comprises printed layers 1722, 1724, 1726, 1728 and 1729. The build progresses from the bottom up, with gravity acting downwards. Generally, the object and the support are separated from one another within a layer by a gap without build material. For example, object build layer 1701 and support build layer 1722 are separated by a gap and do not directly touch one another. The support structure supports the overhanging regions of the object layer at the object and support interfaces 1752, 1754, 1756 and 1758. A numbering convention was followed here where the overlapping object layers, the support layer which supports it, and the interface between the overlapping object layer and the support layer all share the same last digit (e.g., object layer 1702 is joined to support layer 1722 at interface 1752). As will be discussed, the adhesion at these interfaces may be made, selectively, weaker than those interfaces within the object via the present teachings disclosed herein, thereby facilitating the removal of the support from the object. The combination of all of the weaker interfaces leads to a net interface 1740 indicated by the dotted line. More specifically, each of the support interfaces 1752, 1754, 1756 and 1758 combine to allow for the support structure 1720 to be broken away from the object along the net interface line 1740. This net (e.g., more macroscopic) interface need not be planar or even approximate a plane, as shown here. Due to the discretized nature of FFF, the geometry presented in this example creates a net interface approximating a curve in two dimensions which extends in three dimensions (into the page) to approximate a curved surface. The net interface includes a plurality of potentially non-continuous and non-contiguous object-support interfaces. Furthermore, this approximate net interface need not be aligned with the build layers, as is shown in this example.

Various methods of achieving weaker interfaces between the object and the support will now be presented, with reference to this example build geometry. The geometry presented shows the build layers, but does not show the build paths which the nozzle traverses as it deposits build material. The build paths may run into the page, or may run from left to right, or in any other direction within the build layer, for example.

The weaker interfaces between the object 1700 and support 1720 may be realized by use of the inert powder release skins discussed herein. Here, one possible deposition sequence is presented. First, the object layer 1701 and support layer 1722 would be printed. Then, a release skin would be deposited in the area in which the upcoming object layer 1702 will overlap with the previously printed support layer 1722 (specifically, near the future interface 1752). Then object layer 1702 and support layer 1724 would be printed, and in the process interface 1752 is created. This is followed again by a release skin being deposited at interface 1754 before resuming the deposition of the next layer of build material. This pattern repeats until all of the build has been completed. Specifically, weaker adhesion also occurs at the remaining interfaces 1756 and 1758 by first depositing a release skin. In this way, the support structure 1720 may be easily separated from the object 1700 due to the weaker interfaces present where support and object meet.

The weaker interfaces between the object 1700 and support 1720 may also be realized by use of the single build material and multiple temperature strategy, as discussed above. Hereafter, A-type deposition refers to deposition of the MBMP build material at a relatively higher operating temperature and correspondingly a relatively higher liquid fraction, and B-type deposition refers to deposition of the same MBMP build material at a relatively lower operating temperature corresponding to a relatively lower liquid fraction. Recall, the strength of the bond formed between an A-type deposition and its underlayer is stronger than that formed between a B-type deposition and its underlayer. Here, one possible deposition sequence is presented. First, the object layer 1701 and support layer 1722 would be printed using A-type deposition. Then, the region of object layer 1702 which extends on top of support layer 1722 is created with B-type deposition (creating relatively weaker A-B interface 1752). The printing of the remainder of the object layer 1702 and all of the support layer 1724 follows with A-type deposition. In this way, the adhesion between the object material previously deposited and that just deposited is strong (A-A and B-A interfaces). This is followed again by B-type deposition, forming interface 1754 before resuming A-type deposition for the remainder of object layer 1704 and all of support layer 1726. This pattern repeats until all of the build has been completed. Specifically, weaker adhesion occurs at the remaining interfaces 1756 and 1758 by local B-type deposition. In this way, the support structure 1720 may be easily separated from the object 1700 due to the relatively weaker interfaces present where support and object meet. In a sense, the B-type deposition at the interfaces 1752, 1754, 1756 and 1758 can be seen as a joining portion which connects the object 1700 and the support 1720 and which after separation of the object from the support will adhere to and form part of the object.

The weaker interfaces between the object 1700 and the support 1720 may also be realized by use of the multiple build material and multiple temperature strategy. Hereafter, C-type deposition refers to deposition of a primary MBMP build material at a primary operating temperature and D-type deposition refers to the deposition of a secondary build material at a secondary operating temperature, as detailed above. Recall, the interface formed by a D-type deposition onto a C-type underlayer is weaker than a C-type deposition onto a C-type or D-type underlayer, due to their relative liquid fractions and temperatures. Here, one possible deposition sequence is presented. First, the object layer 1701 and the support layer 1722 will be printed using C-type deposition. Then, the region of the object layer 1702 which extends on top of support layer 1722 is created with D-type deposition (creating a weaker C-D interface 1752). The printing of the remainder of the object layer 1702 and all of the support layer 1724 follows with C-type deposition. In this way, the adhesion between the object material previously deposited and that just deposited is strong (C-C and D-C interfaces). This is followed again by D-type deposition, forming interface 1754 before resuming C-type deposition for the remainder of object layer 1704 and all of support layer 1726. This pattern repeats until all of the build has been completed. Specifically, weaker adhesion occurs at the remaining interfaces 1756 and 1758 by locally creating the C-D interface. In this way, the support structure 1720 may be easily separated from the object 1700 due to the weaker interfaces present where support and object meet. In a sense, the D-type deposition at the interfaces 1752, 1754, 1756 and 1758 can be seen as a joining portion which connects the object 1700 and the support 1720 and which after separation of the object from the support will adhere to and form part of the object.

In one case, it is possible to print one or more of the interfaces with normal adhesion (for example, interface 1756 may be printed with normal adhesion, e.g., without the use of the reduced layer adhesion strategies contemplated herein). In this case, the support and the object may still be separated from one another along 1740 as there is very little interface area with normal bonding strength (only the region 1756, for example) since the remainder of the interfaces are relatively weaker by use of one of the strategies discussed herein. This is somewhat analogous to the interrupted deposition of a release skin presented in FIG. 6, although here the interruption is happening between different printed layers as opposed to within one printed layer. Although not shown here, such an interruption may in general also occur within one printed layer.

The methods for tunable layer adhesion described herein may be used individually, or in conjunction with one another. For example, the extrusion temperature of the build material atop of a release skin may be reduced to lower the liquid fraction as another way to tune the layer adhesion. Moreover, in addition to a release skin, two different MBMP build materials may be used to control the liquid fraction at the interface.

In one embodiment, the secondary semi-solid material is of an alloy that does not significantly undergo precipitation hardening. In this way, upon the running of the combination of the build (the object and its supports) through the heat treatment steps for the primary build material, the primary material may gain additional strength and hardness while the support material does not. Typical heat treatments involve holding the object at a solutionizing temperature, followed by a quenching step to lock in a particular microstructure of the alloying elements. Such a mechanism is not present in non-heat treatable alloys. In this way, the support structures may have poorer mechanical properties (e.g., tensile strength) than the those of the object after heat treatment and are therefore easier to remove. As an example, the primary build material may be a 2-series aluminum alloy (alloyed with primarily copper), while the support material may be a 5-series aluminum alloy (alloyed with primarily magnesium).

The term extrudate refers to the build material that is exiting a nozzle, e.g., in a three-dimensional printing process. The verb to condition is used to mean the act of bringing a build material up to a temperature within its working range, where it has rheological behavior suitable for the printing process.

It will be appreciated that the foregoing techniques may be employed alone or in any suitable combination, and may be combined with other time varying extrusion feed rate regimes such as sinusoidal regimes, ramps, and so forth, provided that the aggregate rate profile supports extended clog-free extrusion as contemplated herein.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random-access memory associated with a processor), or a storage device such as a disk drive, flash memory or any other optical, electromagnetic, magnetic, infrared or other device or combination of devices. In another aspect, any of the systems and methods described above may be embodied in any suitable transmission or propagation medium carrying computer-executable code and/or any inputs or outputs from same.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So, for example, performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the present teachings as defined by the following claims, which are to be interpreted in the broadest sense allowable by law.

Aspects of the Present Teachings

The following aspects of the present teachings are intended to be described herein, and this section is to ensure that they are mentioned. They are named aspects, and although they appear similar to claims, they are not claims. However, at some point in the future, the applicants reserve the right to claim any and all of these aspects in this and any related applications.

A1. A method of fabricating a fused filament fabrication FFF build from (metal based multi phase) MBMP material, comprising an object portion and a support portion, the method comprising:

a. fabricating an object portion by depositing by FFF an BMCP object material that has an object composition and an object liquid fraction at deposition;

b. fabricating a joining portion by depositing by FFF a MBMP joining material that has a joining composition and a joining liquid fraction at deposition, so that the joining portion is adhered to the object portion with a strength of object-and-joining adhesion;

c. fabricating a support portion by depositing by FFF MBMP material selected from the group consisting of: the object material and the joining material, so that the support portion is adhered to the joining portion with a strength of support-and-joining adhesion;

the object and joining materials and their respective liquid fractions at deposition having been chosen such that the strength of object-and-joining adhesion differs from the strength of support-and-joining adhesion.

A2. The method of aspect 1, the strength of object-and-joining adhesion being greater than the strength of support-and-joining adhesion.

A3. The method of aspect 1, the strength of object-and-joining adhesion being less than the strength of support-and-joining adhesion.

A4. The method of aspect 1, the strength of object-and-joining adhesion differing from the strength of support-and-joining adhesion such that upon separation, the joining portion separates from the object portion and adheres to the support portion.

A5. The method of aspect 1, the strength of object-and-joining adhesion differing from the strength of support-and-joining adhesion such that upon separation, the joining portion separates from the support portion and adheres to the object portion.

A6. The method of aspect 1, the step of fabricating a support portion comprising depositing object material.

A7. The method of aspect 1, the step of fabricating a support portion comprising depositing joining material.

A8. The method of aspect 1, the object material and the joining material having the same composition and different liquid fractions at deposition.

A9. The method of aspect 1, the support material and the joining material having the same composition and different liquid fractions at deposition.

A10. The method of aspect 1, the object material and the joining material comprising the same composition material.

A11. The method of aspect 1, the object material liquid fraction being greater than the joining material liquid fraction.

A12. A build fabricated by fused filament fabrication FFF build from (metal based multi phase) MBMP material, comprising an object portion and a support portion, the build comprising:

a. an object portion comprising a MBMP object material that has an object composition and an object liquid fraction at deposition;

b. a joining portion comprising a MBMP joining material that has a joining composition and a joining liquid fraction at deposition, the joining portion adhered to the object portion with a strength of object-and-joining adhesion; and

c. a support portion comprising a MBMP material selected from the group consisting of: the object material; and the joining material, the support portion adhered to the joining portion with a strength of support-and-joining adhesion that differs from the strength of object-and-joining adhesion.

A13. The build of aspect 12, the strength of object-and-joining adhesion being greater than the strength of support-and-joining adhesion.

A14. The build of aspect 12, the strength of object-and-joining adhesion being less than the strength of support-and-joining adhesion.

A15. The build of aspect 12, the strength of object-and-joining adhesion differing from the strength of support-and-joining adhesion such that upon separation, the joining portion separates from the object portion and adheres to the support portion.

A16. The build of aspect 12, the strength of object-and-joining adhesion differing from the strength of support-and-joining adhesion such that upon separation, the joining portion separates from the support portion and adheres to the object portion.

A17. The build of aspect 12, the support portion comprising object material.

A18. The build of aspect 12, the support portion comprising joining material.

A19. The build of aspect 12, the object material and the joining material having the same composition and different liquid fractions at deposition.

A20. The build of aspect 12, the support material and the joining material having the same composition and different liquid fractions at deposition.

A21. The build of aspect 12, the object material and the joining material comprising the same composition material.

A22. The build of aspect 21, the object material liquid fraction being greater than the joining material liquid fraction.

A23. A method for fabricating a fused filament fabrication build from metal based multi-phase (MBMP) build material, the method comprising the steps of:

a. fabricating a first, build plurality of layers of lines of build material, with a first build strength of adhesion between the layers of the first build plurality;

b. fabricating a second build plurality of layers of lines of build material, with a second build strength of adhesion between the layers of the second plurality, by depositing a first layer of the second build plurality of layers upon the first build plurality of layers, with a second build strength of adhesion between layers of the second build plurality, the step of depositing a first layer of the second build plurality of layers upon the first build plurality of layers comprising a method that establishes an interface strength of adhesion between the first build plurality and the second build plurality, which interface strength of adhesion is less than each of the first build strength of adhesion and the second strength of adhesion.

A24. The method of aspect 23, the first build plurality of layers comprising a support plurality of layers and the second build plurality of layers comprising an object plurality of layers.

A25. The method of aspect 24, the first build strength of adhesion thus being a support strength of adhesion, being less than the second build strength of adhesion, which is an object strength of adhesion.

A26. An object fabricated by fused filament fabrication from metal based multi-phase (MBMP) build material, the object comprising:

a. a first, build plurality of layers of lines of build material, with a first build strength of adhesion between the layers of the first build plurality;

b. a second build plurality of layers of lines of build material, with a second build strength of adhesion between the layers of the second plurality, a first layer of the second build plurality of layers adhered to the first build plurality of layers, with a second build strength of adhesion between layers of the second build plurality, such that there is an interface between the first layer of the second build plurality of layers and the first build plurality of layers, the interface having an interface strength of adhesion between the first build plurality and the second build plurality, which interface strength of adhesion is less than each of the first build strength of adhesion and the second strength of adhesion.

A27. The object of aspect 26, the first build plurality of layers comprising a support plurality of layers and the second build plurality of layers comprising an object plurality of layers.

A28. The object of aspect 27, the first build strength of adhesion thus being a support strength of adhesion, being less than the second build strength of adhesion, which is an object strength of adhesion.

A29. A method for fabricating an object by fused filament fabrication from metal based multi-phase (MBMP) build material, the method comprising the steps of:

a. fabricating a first, build plurality of layers of lines of build material, with a first build strength of adhesion between the layers of the first build plurality;

b. depositing a release skin onto a layer of the first build plurality of layers, with a first release strength of adhesion between the release skin and the first build plurality of layers, which first release strength is less than the first build strength of adhesion;

c. fabricating a second build plurality of layers of lines of build material, with a second build strength of adhesion between the layers of the second plurality, by depositing a first layer of the second build plurality of layers upon the release skin with a second release strength of adhesion between the release skin and the second plurality of layers, which second release strength of adhesion is less than the first build strength of adhesion and thereafter depositing at least one additional layer of the second build plurality of layers, with a second build strength of adhesion between layers of the second build plurality that is greater than the first and the second release strengths of adhesion.

A30. The method of aspect 29, the first, build plurality of layers comprising a plurality of support layers of a build, and the second build plurality of layers comprising a plurality of object layers of a build.

A31. The method of aspect 29, the first build strength of adhesion and the second build strength of adhesion being substantially equal to each other.

A32. The method of aspect 29, the first and second release strengths of adhesion being substantially equal to each other.

A33. The method of aspect 30, the first build strength of adhesion being less than the second build strength of adhesion.

A34. The method of aspect 29, the first and second release strengths of adhesion being less than the first and second build strengths of adhesion to a degree that permits separation of the first build plurality of layers from the second build plurality of layers by hand forces applied to separate them from each other at the location of the release skin.

A35. The method of aspect 29, the release skin comprising a powder layer.

A36. The method of aspect 35, the step of depositing the release skin comprising depositing the release skin powder with a fluid carrier.

A37. The method of aspect 36, the fluid carrier comprising a liquid.

A38. The method of aspect 36, the fluid carrier comprising a gas.

A39. The method of aspect 36, the fluid carrier comprising a flowable material.

A37. The method of aspect 36, the fluid carrier comprising a liquid.

A38. The method of aspect 36, the fluid carrier comprising a gas.

A39. The method of aspect 36, the fluid carrier comprising a flowable material.

A40. The method of aspect 29, the release skin comprising a material that is dissolvable in a separation solvent, and the build material comprising a material that is insoluble in the separation solvent.

A41. The method of aspect 29, the step of depositing a release layer comprising depositing a plurality of continuous lines of build material.

A42. The method of aspect 29, the step of depositing a release layer comprising depositing a plurality of interrupted lines of build material.

A43. The method of aspect 29, the step of depositing a release layer comprising depositing a plurality of lines of spaced interrupted deposits of build material.

A44. An object fabricated from metal based multi-phase (MBMP) build material, the object comprising:

a. a first, build plurality of layers of lines of build material, with a first build strength of adhesion between the layers of the first build plurality;

b. a release skin adhered to a layer of the first build plurality of layers, with a first release strength of adhesion between the release

and the first build plurality of layers, which first release strength is less than the first build strength of adhesion;

c. a second build plurality of layers of lines of build material, with a second build strength of adhesion between the layers of the second plurality, a first layer of the second build plurality of layers adhered to the release skin with a second release strength of adhesion between the release skin and the second plurality of layers, which second release strength of adhesion is less than the first build strength of adhesion and the second build plurality of layers comprising at least one additional layer, with a second build strength of adhesion between layers of the second build plurality that is greater than the first and the second release strengths of adhesion.

A45. The object of aspect 44, the first, build plurality of layers comprising a plurality of support layers of a build, and the second build plurality of layers comprising a plurality of object layers of a build.

A46. The object of aspect 44, the first build strength of adhesion and the second build strength of adhesion being substantially equal to each other.

A47. The object of aspect 44, the first and second release strengths of adhesion being substantially equal to each other.

A48. The object of aspect 45, the first build strength of adhesion being less than the second build strength of adhesion.

A49. The object of aspect 44, the first and second release strengths of adhesion being less than the first and second build strengths of adhesion to a degree that permits separation of the first build plurality of layers from the second build plurality of layers by hand forces applied to separate them from each other at the location of the release skin.

A50. The object of aspect 29, the release skin comprising a powder layer.

A51. The object of aspect 29, the release skin comprising a continuous powder layer.

A52. The object of aspect 29, the release skin comprising an interrupted powder layer.

A53. The method of aspect 29, the release skin comprising a material that is dissolvable in a separation solvent, and the build material comprising a material that is insoluble in the separation solvent.

A54. A method for fabricating an object from metal based multi-phase (MBMP) build material, the method comprising the steps of:

a. depositing a first plurality of layers of lines of a first build material, at an first deposition temperature, the layers of the first plurality adhering to each other with a first strength of adhesion; and

b. depositing a second plurality of layers of lines of a second, different build material onto the first plurality of layers, at a second layer deposition temperature such that there is an interface between the first the second pluralities of layers, the layers of the second plurality adhering to each other with a second strength of adhesion, the first and second build materials and the first and second deposition temperatures having been chosen such that the interface has an interface strength of adhesion that is less than at least one of the first and the second strength of adhesion.

A55. The method of aspect 54, the step of depositing a second plurality of layers comprising depositing lines in a pattern that comprises a support portion of a build.

A56. The method of aspect 55, the step of depositing a first plurality comprising depositing lines in a pattern that comprises an object portion of a build.

A57. The method of aspect 54 further comprising the step of depositing a third plurality of layers of lines of the first build material onto the second plurality of lines of the second build material, at a third temperature such that there is a second interface between the second and the third pluralities of layers, the first and second build materials and the third deposition temperatures having been chosen such that the second interface has an interface strength of adhesion that is less than at least one of the first and the second strength of adhesion.

A58. The method of aspect 57, further wherein:

a. the step of depositing a first plurality comprising depositing lines in a pattern that comprises a support portion of a build;

b. the step of depositing a third plurality comprising depositing lines in a pattern that comprises an object portion of a build; and

c. the step of depositing a second plurality comprising depositing lines in a pattern that comprises an interface portion between a support portion and an object portion of a build

A59. The method of aspect 56, further comprising the step of separating the support portion of the build from the object portion of the build.

A60. The method of aspect 55, the step of depositing an overlayer comprising depositing lines in a pattern that comprises an object portion of a build.

A61. The method of aspect 56, the first and second build materials and the first and second deposition temperatures having been chosen such that the liquid fraction of the first material at the first deposition temperature is higher than the liquid fraction of the second build material at the second deposition temperature.

A62. The method of aspect 58, the first and second build materials and the first and second deposition temperatures having been chosen such that the liquid fraction of the first material at the first deposition temperature is higher than the liquid fraction of the second build material at the second deposition temperature.

A63. The method of aspect 56, the first and second build materials and the first and second deposition temperatures having been chosen such that the liquid fraction of the first material at the first deposition temperature is higher than the liquid fraction of the first build material at the second deposition temperature.

A64. The method of aspect 58, the first and second build materials and the first and second deposition temperatures having been chosen such that the liquid fraction of the first material at the first deposition temperature is higher than the liquid fraction of the first build material at the second deposition temperature.

A65. The method of aspect 56, the first and second build materials and the first and second deposition temperatures having been chosen such that the liquid fraction of the first material at the first deposition temperature is higher than the liquid fraction of the first build material at the second deposition temperature and also higher than the liquid fraction of the second build material at the second deposition temperature.

A66. The method of aspect 58, the first and second build materials and the first and second deposition temperatures having been chosen such that the liquid fraction of the first material at the first deposition temperature is higher than the liquid fraction of the first build material at the second deposition temperature and also higher than the liquid fraction of the second build material at the second deposition temperature.

A67. The method of aspect 1, the object material and the joining material comprising different composition material.

A68. The build of aspect 12, the object material and the joining material comprising different composition material.

A69. The method of aspect 1, the object material and the joining material comprising different composition material.

A70. The method of aspect 69, the step of fabricating a support portion comprising depositing support material on top of the joining portion, with the liquid fraction of the joining material at deposition of the support material being greater than the liquid fraction of the joining material at deposition of the joining material.

A71. The method of aspect 69, the step of fabricating an object portion comprising depositing object material on top of the joining portion with the liquid fraction of the joining material at deposition of the object material being greater than the liquid fraction of the joining material at deposition of the joining material.

A72. The method of aspect 69, the step of fabricating a joining portion comprising depositing joining material on top of the support portion, the step of fabricating the object portion comprising depositing object material on top of the joining portion.

A73. The method of aspect 72, the liquid fraction of the joining material at deposition of the object material being greater than the liquid fraction of the joining material at deposition of the joining material.

A74. The method of aspect 72, the liquid fraction of the support material at deposition of the joining material being less than the liquid fraction of the support material at the deposition of the support material.

A75. The method of aspect 69, the step of fabricating a joining portion comprising depositing joining material on top of the object portion, the step of fabricating the support portion comprising depositing support material on top of the joining portion.

A76. The method of aspect 75, the liquid fraction of the joining material at deposition of the support material being greater than the liquid fraction of the joining portion at deposition of the joining portion.

A77. The method of aspect 75, the liquid fraction of the object material at deposition of the joining material being less than the liquid fraction of the object material at deposition of the object portion.

1. A method of fabricating a fused filament fabrication (FFF) build from metal based multi phase (MBMP) material, comprising an object portion and a support portion, the method comprising:
a. fabricating an object portion by depositing by FFF an MBMP object material that has an object composition and an object liquid fraction at deposition;
b. fabricating a joining portion by depositing by FFF a MBMP joining material that has a joining composition and a joining liquid fraction at deposition, so that the joining portion is adhered to the object portion with a strength of object-and-joining adhesion; and
c. fabricating a support portion by depositing by FFF MBMP material selected from the group consisting of the object material and the joining material, so that the support portion is adhered to the joining portion with a strength of support-and-joining adhesion,
wherein the object and joining materials and their respective liquid fractions at deposition having been chosen such that the strength of object-and-joining adhesion differs from the strength of support-and-joining adhesion.

2. The method of claim 1, wherein the strength of object-and-joining adhesion is greater than the strength of support-and-joining adhesion.

3. The method of claim 1, wherein the strength of object-and-joining adhesion is less than the strength of support-and-joining adhesion.

4. The method of claim 1, wherein the strength of object-and-joining adhesion differs from the strength of support-and-joining adhesion such that upon separation, the joining portion separates from the object portion and adheres to the support portion.

5. The method of claim 1, wherein the strength of object-and-joining adhesion differs from the strength of support-and-joining adhesion such that upon separation, the joining portion separates from the support portion and adheres to the object portion.

6. The method of claim 1, wherein the step of fabricating a support portion comprises depositing object material.

7. The method of claim 1, wherein the step of fabricating a support portion comprises depositing joining material.

8. The method of claim 1, wherein the object material and the joining material have the same composition and different liquid fractions at deposition.

9. The method of claim 1, wherein the support material and the joining material have the same composition and different liquid fractions at deposition.

10. The method of claim 1, wherein the object material and the joining material comprise the same composition material.

11. The method of claim 1, wherein the object material and the joining material comprise different composition material.

12. The method of claim 1, wherein the object material liquid fraction is greater than the joining material liquid fraction.

13. A build fabricated by fused filament fabrication (FFF) from metal based multi phase (MBMP) material, comprising:
a. an object portion comprising a MBMP object material that has an object composition and an object liquid fraction at deposition;
b. a joining portion comprising a MBMP joining material that has a joining composition and a joining liquid fraction at deposition, the joining portion adhered to the object portion with a strength of object-and-joining adhesion; and
c. a support portion comprising a MBMP material selected from the group consisting of the object material and the joining material, wherein the support portion is adhered to the joining portion with a strength of support-and-joining adhesion that differs from the strength of object-and-joining adhesion.

14. The build of claim 13, wherein the strength of object-and-joining adhesion is greater than the strength of support-and-joining adhesion.

15. The build of claim 13, wherein the strength of object-and-joining adhesion is less than the strength of support-and-joining adhesion.

16. The build of claim 13, wherein the strength of object-and-joining adhesion differs from the strength of support-and-joining adhesion such that upon separation, the joining portion separates from the object portion and adheres to the support portion.

17. The build of claim 13, wherein the strength of object-and-joining adhesion differs from the strength of support-and-joining adhesion such that upon separation, the joining portion separates from the support portion and adheres to the object portion.

18. The build of claim 13, wherein the support portion comprises object material.

19. The build of claim 13, wherein the support portion comprises joining material.

20. The build of claim 13, wherein the object material and the joining material have the same composition and different liquid fractions at deposition.

21-30. (canceled)
